(19) United States
(12) Patent Application Publication
(10) Pub. No.: US 2017/0047889 A1
(43) Pub. Date: Feb. 16, 2017

(54) Lightweight Structures for Enhancing the Thermal Emissivity of Surfaces

(71) Applicant: California Institute of Technology, Pasadena, CA (US)

(72) Inventors: Harry A. Atwater, South Pasadena, CA (US); Sergio Pellegrino, Pasadena, CA (US); Seyed Ali Hajimiri, La Canada, CA (US); Dennis Callahan, Los Angeles, CA (US); Emily C. Warmann, Riverside, CA (US); Pilar Espinet Gonzalez, Pasadena, CA (US); Jeffrey P. Bosco, Los Angeles, CA (US)

(73) Assignee: California Institute of Technology, Pasadena, CA (US)

(21) Appl. No.: 15/233,828

(22) Filed: Aug. 10, 2016

Related U.S. Application Data
(60) Provisional application No. 62/203,159, filed on Aug. 10, 2015.
(60) Provisional application No. 62/220,017, filed on Sep. 17, 2015.
(60) Provisional application No. 62/239,706, filed on Oct. 9, 2015.
(60) Provisional application No. 62/264,500, filed on Dec. 8, 2015.
(60) Provisional application No. 62/268,632, filed on Dec. 17, 2015.
(60) Provisional application No. 62/269,901, filed on Dec. 18, 2015.
(60) Provisional application No. 62/270,425, filed on Dec. 21, 2015.
(60) Provisional application No. 62/295,947, filed on Feb. 16, 2016.
(60) Provisional application No. 62/320,819, filed on Apr. 11, 2016.
(60) Provisional application No. 62/330,341, filed on May 2, 2016.
(60) Provisional application No. 62/340,644, filed on May 24, 2016.
(60) Provisional application No. 62/352,392, filed on Jun. 20, 2016.
(60) Provisional application No. 62/366,720, filed on Jul. 26, 2016.

(51) Int. Cl. H02S 40/42; H02S 40/22

(52) U.S. Cl. CPC H02S 40/42; H02S 40/22

(57) ABSTRACT

Systems and methods in accordance with various embodiments of the invention implement textured metasurfaces that can provide for enhanced thermal emissivity. In one embodiment, a lightweight solar power generator includes: at least one photovoltaic cell including a photovoltaic material; at least one concentrator, configured to focus incident solar radiation onto the photovoltaic material; and at least one textured metasurface characterized by its inclusion of a plurality of microstructures, each having a characteristic lateral dimension of between approximately 1 μm and approximately 100 μm patterned thereon; where the at least one textured metasurface is disposed such that it is in thermal communication with at least some portion of the lightweight solar power generator that generates heat during the normal operation of the lightweight solar power generator, and is thereby configured to dissipate heat generated by the at least some portion.

### CROSS-REFERENCE TO RELATED APPLICATIONS

The current application claims priority to: U.S. Provisional Application No. 62/269,901, entitled “Lightweight Structures for Enhancing the Thermal Emissivity of Surfaces in Extraterrestrial Applications”, filed Dec. 18, 2015; U.S. provisional patent application Ser. No. 62/203,159 entitled “Space-based Solar Power System—2,” filed on Aug. 10, 2015; U.S. provisional patent application Ser. No. 62/220,017 entitled “Space-based Solar Power System—3,” filed on Sep. 17, 2015; U.S. provisional patent application Ser. No. 62/239,706 entitled “Space-based Solar Power System—4,” filed on Oct. 9, 2015; U.S. provisional patent application Ser. No. 62/264,500 entitled “Space-based Solar Power System—5,” filed on Dec. 8, 2015; U.S. provisional patent application Ser. No. 62/268,632 entitled “Space-based Solar Power System—6,” filed on Dec. 17, 2015; U.S. provisional patent application Ser. No. 62/270,425 entitled “Space-based Solar Power System—7,” filed on Dec. 21, 2015; U.S. provisional patent application Ser. No. 62/295,947 entitled “Space-based Solar Power System—8,” filed on Feb. 16, 2016; U.S. provisional patent application Ser. No. 62/320,819 entitled “Space-based Solar Power System—9,” filed on Apr. 11, 2016; U.S. provisional patent application Ser. No. 62/330,341 entitled “Space-based Solar Power System—10,” filed on May 2, 2016; U.S. provisional patent application Ser. No. 62/340,644 entitled “Space-based Solar Power System—11,” filed on May 24, 2016; U.S. provisional patent application Ser. No. 62/352,392 entitled “Space-based Solar Power System—12,” filed on Jun. 20, 2016; U.S. provisional patent application Ser. No. 62/366,720 entitled “Space-based Solar Power System—13,” filed on Jul. 26, 2016; all of which are incorporated by reference herein in their entirety.

### FIELD OF THE INVENTION

The present invention is related to increasing the thermal emissivity of surfaces.

### BACKGROUND

By the middle of the 20^{th} century, mankind had achieved sufficient technological ability to begin more intimately exploring outer space. Indeed, since the mid-20^{th} century, we have been able to land a man on the moon, and we now routinely send and return spacecraft and astronauts into outer space. As such efforts are now routine, it can be easy to overlook the fact that such undertakings are the result of intensive multi-disciplinary efforts. For example, amongst a host of engineering considerations, careful attention must be paid to issues regarding thermal management—e.g. making sure that spacecraft and astronauts are maintained at suitable operating temperatures. Thus, for instance, the Space Shuttle Orbiter includes a Thermal Protection System (TPS) designed to address issues related to thermal management. While the TPS is an intricate and comprehensive system, one of its most salient features is the series of white and black tiles that enclose the Orbiter. Interestingly, the TPS is primarily white on the upper surface and black on the lower surface to control on-orbit heating from solar radiation and to maximize heat rejection during reentry. By rotating the orbiter so that the more reflective (and less absorbent) white upper surface is towards the sun, the solar heating can be reduced. Conversely, directing the black lower surface towards the sun would enhance the solar heating. The high-emissivity black region should be on the lower surface to maximize the heat rejection (in the form of thermal radiation) from the TPS during reentry where this region experiences the highest heat load.

### SUMMARY OF THE INVENTION

Systems and methods in accordance with various embodiments of the invention implement textured metasurfaces that can provide for enhanced thermal emissivity. In one embodiment, a lightweight solar power generator includes: at least one photovoltaic cell including a photovoltaic material; at least one concentrator, configured to focus incident solar radiation onto the photovoltaic material; at least one power transmitter, including at least one transmission antenna, where the power transmitter is configured to receive electrical current from the photovoltaic cell and convert the electrical current to a wireless power transmission; and at least one textured metasurface characterized by its inclusion of a plurality of microstructures, each having a characteristic lateral dimension of between approximately 1 μm and approximately 100 μm patterned thereon; where the at least one textured metasurface is disposed such that it is in thermal communication with at least some portion of the lightweight solar power generator that generates heat during the normal operation of the lightweight solar power generator, and is thereby configured to dissipate heat generated by the at least some portion.

In another embodiment, the microstructures are each characterized by a lateral dimension of between approximately 5 μm and approximately 50 μm.

In still another embodiment, the lightweight solar power generator further includes a circuit that generates heat during the normal operation of the lightweight solar power generator, where the textured metasurface is disposed in thermal communication with the circuit and is thereby configured to dissipate heat generated by the circuit.

In yet another embodiment, the textured metasurface is disposed in thermal communication with the at least one concentrator.

In still yet another embodiment, the textured metasurface is disposed in thermal communication with the at least one photovoltaic cell.

In a further embodiment, each of the microstructures is characterized by symmetry about an axis orthogonal to that portion of the surface that each respective microstructure is disposed on.

In a still further embodiment, at least one microstructure is hemispherical.

In a yet further embodiment, at least one microstructure is conical.

In a still yet further embodiment, at least one microstructure is cylindrical.

In another embodiment, at least one microstructure conforms to the shape of a rectangular prism.

In still another embodiment, at least one microstructure is spherical.

In yet another embodiment, each of the plurality of microstructures have an identical shape.

In still yet another embodiment, the microstructures are characterized by a height of between approximately 1 μm and 10 μm.

In a further embodiment, the microstructures are characterized by a height of between approximately 2.5 μm and approximately 5 μm.

In a still further embodiment, the plurality of microstructures are disposed in a grid-like manner characterized by a period of between approximately 1 μm and approximately 100 μm, and a duty cycle of between approximately 0.1 and 0.8.

In a yet further embodiment, the plurality of microstructures are disposed in a grid-like manner characterized by a period of between approximately 1 μm and approximately 20 μm.

In a still yet further embodiment, the plurality of microstructures includes at least one of: KAPTON polyimide and SiO₂.

In another embodiment, the plurality of microstructures are disposed on a layer of chromium.

In still another embodiment, the layer of chromium is approximately 2 nm in thickness.

In yet another embodiment, the layer of chromium is disposed on one of: a layer of SiO₂ and a layer of KAPTON polyimide.

The features and advantages described in the specification are not all inclusive and, in particular, many additional features and advantages will be apparent to one of ordinary skill in the art in view of the drawings, specification, and claims.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 illustrates the application of Kirchoff's Law in the instant context in accordance with certain embodiments of the invention.

FIGS. 2A-2D illustrate the patterning of microstructures relative to conventional coating in accordance with certain embodiments of the invention.

FIGS. 3A and 3B illustrate the effect of incorporating hemispherical microscale structures on the thermal emissivity of a surface in accordance with certain embodiments of the invention.

FIGS. 4A-4C illustrate the effect of the incorporation of prism-shaped microscale structures on the thermal emissivity of a surface in accordance with certain embodiments of the invention.

FIGS. 5A and 5B illustrate the effect of the incorporation of a microscale structure of a KAPTON material on the thermal emissivity of a surface in accordance with certain embodiments of the invention.

FIGS. 6A-6D illustrate the patterning of rectangular prism-shaped microstructures on various surfaces in accordance with certain embodiments of the invention.

FIGS. 7A-7C illustrate the patterning of cylindrical microstructures on various surfaces in accordance with certain embodiments of the invention.

FIGS. 8A-8C illustrate the patterning of conical microstructures on various surfaces in accordance with certain embodiments of the invention.

FIG. 9 illustrates a suitable context for the patterning of the described microstructures in accordance with certain embodiments of the invention.

FIG. 10 conceptually illustrates a large-scale space-based solar power station with a plurality of power satellite modules in geosynchronous orbit about the Earth, which can benefit from the incorporation of lightweight structures configured to enhance thermal emissivity in accordance with certain embodiments of the invention.

FIG. 11 conceptually illustrates a large-scale space-based solar power station with a plurality of power satellite modules flying in a rectangular orbital formation, which can benefit from the incorporation of lightweight structures configured to enhance thermal emissivity in accordance with certain embodiments of the invention.

FIG. 12 conceptually illustrates a large-scale space-based solar power station, satellite modules, and a cross-sectional view of a modular power generation tile, which can benefit from the incorporation of lightweight structures configured to enhance thermal emissivity in accordance with certain embodiments of the invention.

FIG. 13A conceptually illustrates a cross-sectional view of a modular power generation tile, which can benefit from the incorporation of lightweight structures configured to enhance thermal emissivity in accordance with certain embodiments of the invention.

FIG. 13B conceptually illustrates a cross-sectional view of a photovoltaic cell, which can benefit from the incorporation of lightweight structures configured to enhance thermal emissivity in accordance with certain embodiments of the invention.

FIG. 13C conceptually illustrates a block-diagram for an integrated circuit suitable for utilization in a power transmitter forming part of a power generation tile, which can benefit from the incorporation of lightweight structures configured to enhance thermal emissivity in accordance with certain embodiments of the invention.

FIG. 14 conceptually illustrates an array of power generation tiles in which the antenna elements of the power generation tiles are configured as a phased array, which can benefit from the incorporation of lightweight structures configured to enhance thermal emissivity in accordance with certain embodiments of the invention

FIG. 15 conceptually illustrates the power density distribution at a ground receiver from a transmission of power from a phased array of antennas on a solar power station, which can benefit from the incorporation of lightweight structures configured to enhance thermal emissivity in accordance with certain embodiments of the invention.

FIG. 16 conceptually illustrates dynamic power allocation from a large-scale space-based solar power system, which can benefit from the incorporation of lightweight structures configured to enhance thermal emissivity in accordance with certain embodiments of the invention.

FIGS. 17A and 17B conceptually illustrate electronic beam steering using relative phase offset between elements of a phased array within the context of a space-based solar power station that can benefit from the incorporation of lightweight structures configured to enhance thermal emissivity in accordance with certain embodiments of the invention.

FIG. 18A conceptually illustrates a large-scale space-based solar power station and a compactable satellite module in a deployed configuration, which can benefit from the incorporation of lightweight structures configured to enhance thermal emissivity in accordance with certain embodiments of the invention.

FIG. 18B conceptually illustrates a retracted compactable satellite module, according to FIG. 18A in a retracted configuration, which can benefit from the incorporation of lightweight structures configured to enhance thermal emissivity in accordance with certain embodiments of the invention.

FIG. 19 conceptually illustrates a compactable satellite module having a biaxial folding configuration, which can benefit from the incorporation of lightweight structures configured to enhance thermal emissivity in accordance with certain embodiments of the invention.

FIG. 20 provides images of the compaction of a membrane using the compaction technique of FIG. 19.

FIGS. 21A-21D conceptually illustrate a cross-sectional view of a compactable satellite module having a slip folding and wrapping configuration, which can benefit from the incorporation of lightweight structures configured to enhance thermal emissivity in accordance with certain embodiments of the invention.

FIG. 22 conceptually illustrates a perspective view of a compactable satellite module having a slip folding and wrapping configuration, which can benefit from the incorporation of lightweight structures configured to enhance thermal emissivity in accordance with certain embodiments of the invention.

FIG. 23 provides images of the compaction of a membrane using the compaction technique of FIG. 22.

FIG. 24 conceptually illustrates a boom deployment mechanism for a compactable satellite module, which can benefit from the incorporation of lightweight structures configured to enhance thermal emissivity in accordance with certain embodiments of the invention.

FIG. 25 conceptually illustrates a spin deployment mechanism for a compactable satellite module, which can benefit from the incorporation of lightweight structures configured to enhance thermal emissivity in accordance with certain embodiments of the invention.

FIGS. 26A and 26B illustrate data pertaining to an ALTADEVICES photovoltaic material that can be incorporated in a space-based solar power station, which can benefit from the incorporation of lightweight structures configured to enhance thermal emissivity in accordance with certain embodiments of the invention.

FIG. 27 illustrates a cross-section view of a portion of a photovoltaic cell that can be incorporated in a space-based solar power station, which can benefit from the incorporation of lightweight structures configured to enhance thermal emissivity in accordance with certain embodiments of the invention.

FIG. 28 depicts an illustrative energy balance for an ALTADEVICES Dual Junction Cell that can be incorporated in a space-based solar power station, which can benefit from the incorporation of lightweight structures configured to enhance thermal emissivity in accordance with certain embodiments of the invention.

FIGS. 29A-29C illustrate a Cassegrain configuration that can be implemented in a space-based solar power station, which can benefit from the incorporation of lightweight structures configured to enhance thermal emissivity in accordance with certain embodiments of the invention.

FIG. 30 illustrates the operation of a Parabolic Trough configuration that can be implemented in a space-based solar power station, which can benefit from the incorporation of lightweight structures configured to enhance thermal emissivity in accordance with certain embodiments of the invention.

FIGS. 31A and 31B illustrate a Venetian Blinds configuration that can be incorporated in a space-based solar power station, which can benefit from the incorporation of lightweight structures configured to enhance thermal emissivity in accordance with certain embodiments of the invention.

FIG. 32A illustrates the constitution of a Venetian Blinds configuration in a space-based solar power station, which can benefit from the incorporation of lightweight structures configured to enhance thermal emissivity in accordance with an embodiment of the invention.

FIG. 32B illustrates a Venetian Blinds configuration coupled with a power transmitter adapted for use in a space-based solar power station, which can benefit from the incorporation of lightweight structures configured to enhance thermal emissivity in accordance with an embodiment of the invention.

FIG. 33 illustrates how the mass of a power generation tile can be significantly reduced by implementing concentrators within the context of a space-based solar power station, which can benefit from the incorporation of lightweight structures configured to enhance thermal emissivity in accordance with certain embodiments of the invention.

FIG. 34 illustrates how the efficiency of a power generation tile can be a stronger function of the number of junctions implemented relative to the concentration implemented.

FIGS. 35A and 35B illustrate using a conductive carbon spring and a conductive reflector as the metallic contacts for a photovoltaic material in the context of a space-based solar power station, which can benefit from the incorporation of lightweight structures configured to enhance thermal emissivity in accordance with certain embodiments of the invention.

FIGS. 36A-36C illustrate using a reflector as the contacts for a photovoltaic material in the context of a space-based solar power station, which can benefit from the incorporation of lightweight structures configured to enhance thermal emissivity in accordance with certain embodiments of the invention.

FIG. 37 illustrates using carbon springs as the contacts for a photovoltaic material in the context of a space-based solar power station, which can benefit from the incorporation of lightweight structures configured to enhance thermal emissivity in accordance with certain embodiments of the invention.

FIG. 38 illustrates photovoltaic materials electrically connected in parallel in the context of a space-based solar power station, which can benefit from the incorporation of lightweight structures configured to enhance thermal emissivity in accordance with certain embodiments of the invention.

### DETAILED DESCRIPTION

Turning now to the drawings, lightweight structures configured to enhance the thermal emissivity of an attached surface in accordance with many embodiments of the invention are illustrated. The implementation of such structures can be particularly useful in an extraterrestrial context. In particular, it should be appreciated that an extraterrestrial environment is often characterized by a vacuum. Accordingly, conductive and convective modes of rejecting heat may not be particularly effective in such a context (if even at all). Thus, techniques for rejecting heat in these scenarios often rely on thermal radiation. For example, as alluded to above, the Space Shuttle Orbiter relies on the implementation of numerous ceramic tiles that enclose the spacecraft that operate largely based on the principles of thermal radiation. While solutions like these currently exist for managing thermal issues in outer space, such currently implemented solutions can be bulky and cumbersome.

For instance, while the mass of the tiles relative to the overall weight of the Orbiter may be relatively negligible, the absolute mass of the ceramic tiles can be substantial. In many extraterrestrial applications, having to rely on such massive and cumbersome systems for thermal management may be sub-optimal. For example, in many instances, it may be desirable to place into orbit spacecraft that do not have a form factor suitable for the implementation of such bulky, massive, and cumbersome tiles. In numerous instances, it may be desirable to launch spacecraft into orbit characterized by a relatively light weight; as can be appreciated, launching a spacecraft characterized by a relatively light weight can be economically beneficial insofar as doing so involves reduced launch costs. Additionally, lightweight spacecraft can be further beneficial insofar as they can be more maneuverable. Having to rely on bulky, cumbersome, and massive solutions for thermal management can negate these critical advantages inherent to lightweight spacecraft. Accordingly, many embodiments of the implement lightweight structures that can enhance the thermal emissivity of surfaces configured for extraterrestrial application.

Metamaterials are generally understood to be artificially synthesized materials that are typically characterized by a repeating pattern of structural elements that have characteristic lengths on the order of less than the wavelength of the waves that they are meant to impact. For example, ‘photonic metamaterials’ (also known as ‘optical metamaterials’), which are meant to control the propagation of visible light, include structural elements that have characteristic lengths on the order of nanometers—by contrast, the wavelength of visible light is on the order of hundreds of nanometers. Much research has been devoted to developing such materials that have highly counterintuitive, but practical, optical characteristics—for example, metamaterials having negative indices of refraction have been developed and are the subject of much study.

‘Metasurfaces’ can be thought of as two-dimensional metamaterials insofar as they are characterized by a repeating pattern of subwavelength structures, and they can offer many of the same advantages as metamaterials. Indeed, metasurfaces can even be advantageous relative to metamaterials in many respects. For example, metasurfaces can be made to more efficiently transmit light as compared to metamaterials.

In general, metamaterials and metasurfaces are understood to possess vast potential for the robust control of electromagnetic waves. Metasurfaces are discussed in greater detail in International Patent Application No. PCT/US15/19315, the disclosure of which is hereby incorporated by reference.

Against this backdrop, many embodiments of the invention implement an array of micro- and/or nanoscale structures configured to effectively enhance the thermal emissivity of an attached surface. In effect the patterning of the micro- and/or nanoscale structures onto a surface can convert the associated surface into a ‘metasurface.’ As the goal of doing so is to facilitate thermal emissivity, in many embodiments, the structures are sized so as to facilitate infrared radiation in accordance with metasurface/metamaterials principles. As can be appreciated, such lightweight structures can offer a substantial weight savings relative to conventionally implemented coatings for the purpose of thermal emissivity. Notably, these microstructures can be implemented in any of a variety of applications.

Lightweight structures configured to enhance thermal emissivity of surfaces are now discussed in greater detail below.

### Lightweight Structures Configured to Enhance the Thermal Emissivity of Associated Surfaces

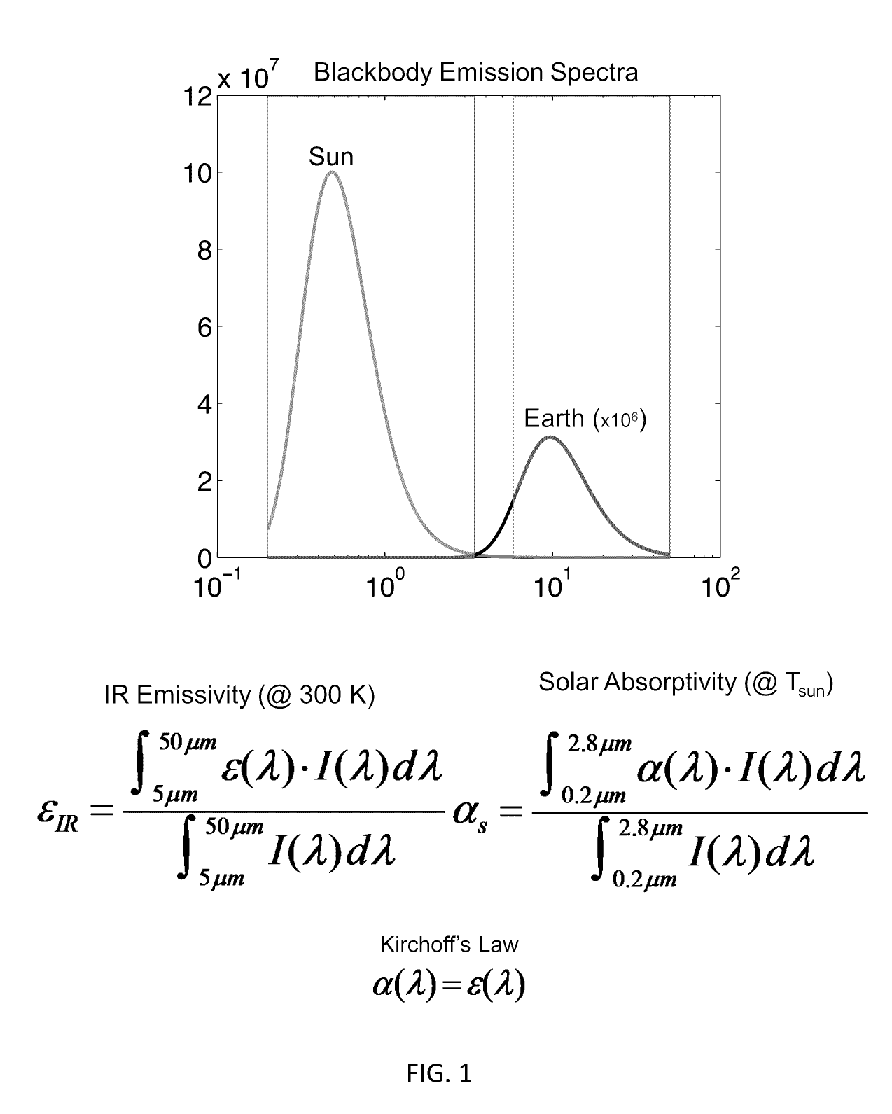

In many embodiments, lightweight micro- and/or nanoscale structures are incorporated onto a surface to improve the thermal emissivity of the surface. For instance, in several embodiments, structures that have dimensions approximately on the order of wavelengths of thermally radiated light (e.g. infrared radiation) are incorporated onto a surface, or are otherwise in thermal communication with the surface. Such structures can cause thermally generated infrared photons to interact with the material to a greater extent, and can thereby allow for greater overall thermal radiation, which in turn causes higher cooling rates. This can be understood as the inverse process of increasing absorption of incident photons by surface texturing, as described by Kirchoff's law of thermal radiation, which states that the emissivity of an arbitrary body is equal to its absorptivity. FIG. 1 illustrates the application of Kirchoff's law in the instant context. In general, structures with characteristic dimensions (e.g. width and/or depth, alternatively a ‘lateral dimension’) approximately on the order of wavelengths of thermally radiated light (inclusive of dimensions between approximately 1 μm and approximately 100 μm or more) can modify the absorptivity/emissivity of a material by causing electromagnetic resonances. A plurality of these structures can be implemented so as to create a ‘textured metasurface’ in accordance with many embodiments of the invention. In general, when such surfaces are interconnected with (e.g. in thermal communication with) another surface, they can facilitate its cooling via conduction and thermal radiation. For example, in many embodiments, implemented microstructures have characteristic dimensions (e.g. a lateral dimension) of between approximately 1 μm and approximately 100 μm. In several embodiments, implemented microstructures have characteristic dimensions between approximately 5 μm and approximately 50 μm. While certain dimensions are referenced, it should be clear that features of any suitable dimension that can texture a surface so as to increase its emissivity can be incorporated in accordance with embodiments of the invention.

In many embodiments, particular materials are implemented that are characterized by electromagnetic resonances that can further facilitate enhanced thermal emissivity. For instance, in many embodiments, materials are implemented that are characterized by electromagnetic resonances that are correlated with infrared radiation. Thus for instance, SiO₂, SiC, or a polyimide material may be implemented in accordance with certain embodiments of the invention. A polyimide is a polymer of imide monomers, and an imide is a functional group consisting of two acyl groups bound to nitrogen. A classic polyimide that can be implemented is KAPTON polyimide (a material produced by DUPONT). KAPTON polyimide [chemical formula: poly (4,4′-oxydiphenylene-pyromellitimide)], is a type of polyimide that can be synthesized by condensation of pyromellitic dianhydride and 4,4′-oxydiphenylene. KAPTON films can be stable across a wide range of temperatures (approximately −269° C. to approximately +400° C.). In some embodiments, KAPTON HN is used. In a number of embodiments, KAPTON B is used. Other suitable materials may include: KAPTON FN, KAPTON HPP-ST, KAPTON VN, KAPTON 100CRC, KAPTON CR, KAPTON FCR, KAPTON 150FCRC019, KAPTON FPC, KAPTON 150FWN019, KAPTON 120FWN616B, KAPTON 150FWR019, KAPTON GS, KAPTON 200FWR919, KAPTON 150PRN411, KAPTON PST, KAPTON MT, KAPTON PV9100, and KAPTON 200RS100. Of course, it should be appreciated that any suitable material that can facilitate the enhancement of the thermal emissivity of an associated surface can be implemented in accordance with embodiments of the invention.

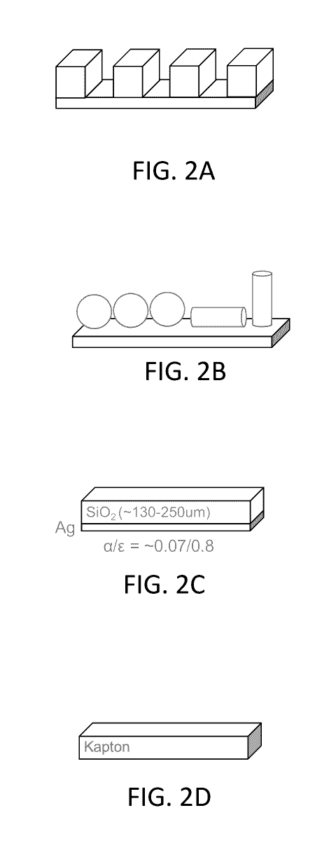

FIGS. 2A and 2B illustrate examples of structures having dimensions on the order of wavelengths of thermally radiated light that can be incorporated onto the solar concentrators. In particular, FIG. 2A illustrates a series of prisms that can be incorporated, while FIG. 2B illustrates a series of spheres and cylinders. But of course, it should be clear that features having any of a variety of shapes can be implemented in accordance with embodiments of the invention. Additionally, the structures can be scaled so as to result in the desired electromagnetic resonances. For purposes of comparison, FIGS. 2C and 2D illustrate examples of conventionally implemented non-textured layers of material for increasing emissivity.

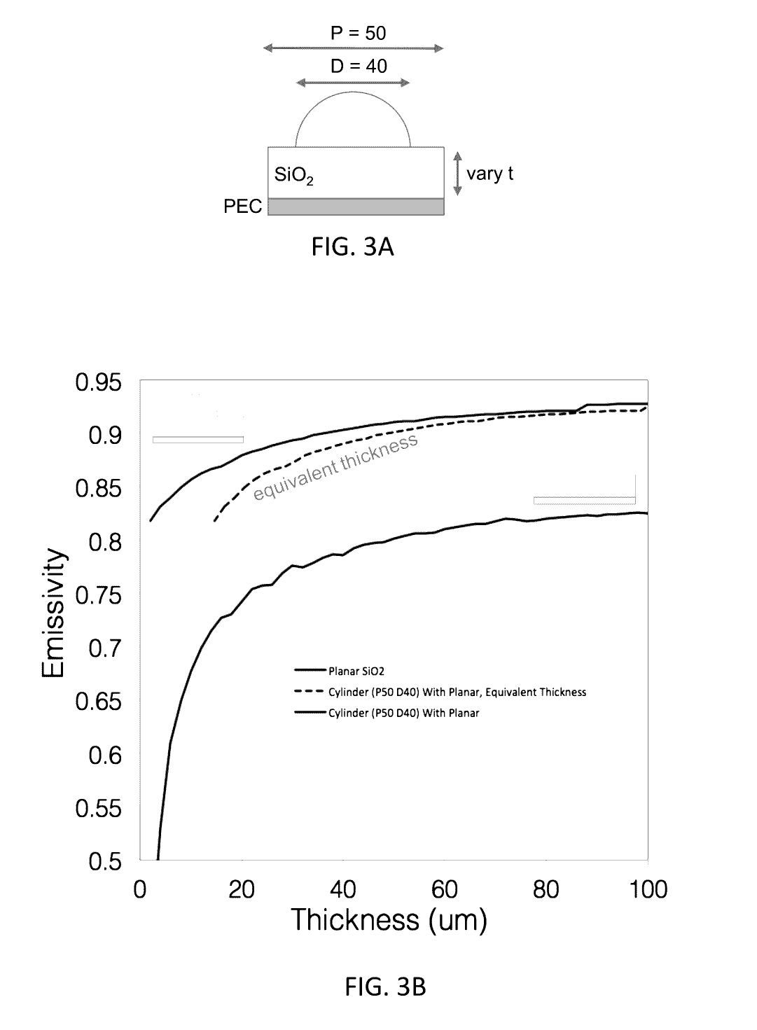

FIGS. 3A and 3B illustrate a structure characterized by having a dimension on the microscale, and how the incorporation of a texture including such structures onto a surface can elevate its emissivity relative to when no such texture is incorporated. In particular, FIG. 3A depicts the geometry of the structure (hemispherical in shape) that is iteratively incorporated onto the surface. More specifically, the diameter is approximately 40 μm, and the pitch is approximately 50 μm. FIG. 3B illustrates the emissivity of the surface (as a function of surface thickness) relative to if no such texture is included. Note that the graph indicates that, for any given surface thickness, the emissivity of the surface having the texture including the illustrated structure is greater.

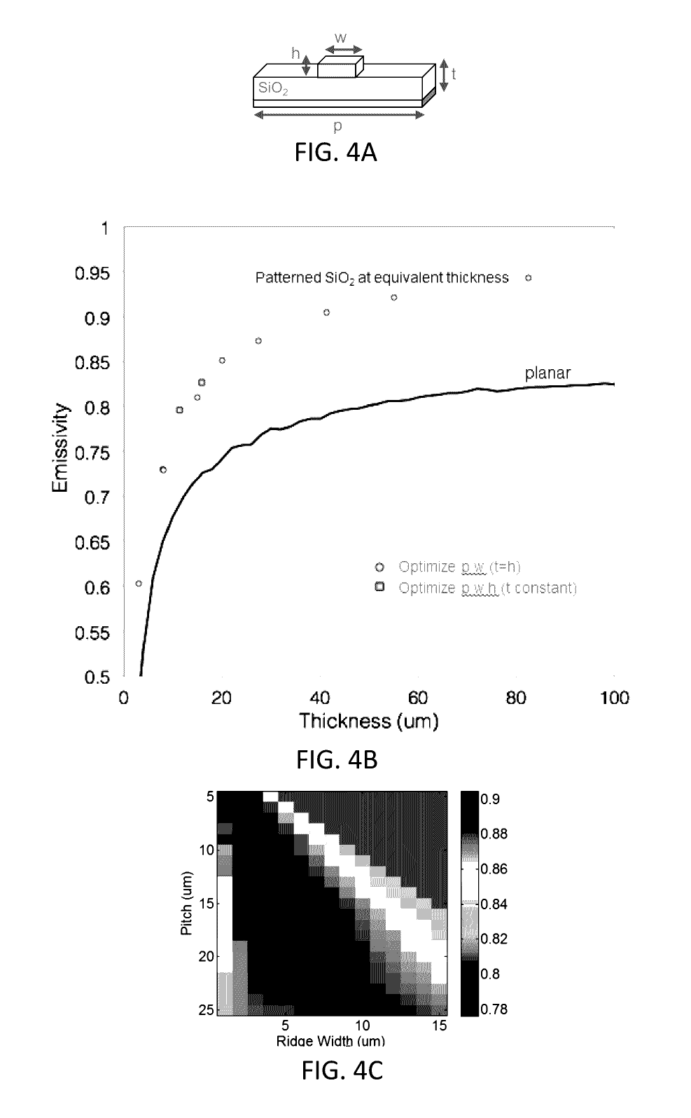

Similarly, FIGS. 4A-4C present further data along these lines. In particular, FIG. 4A illustrates computations for a different geometry—a prism. FIG. 4B illustrates the relative thermal emissivity increase that the texturing can cause. In this example, each point was optimized over pitch and width. Note that the calculations were implemented using Rigorous Coupled Wave Analysis (RCWA), depicted in FIG. 4C.

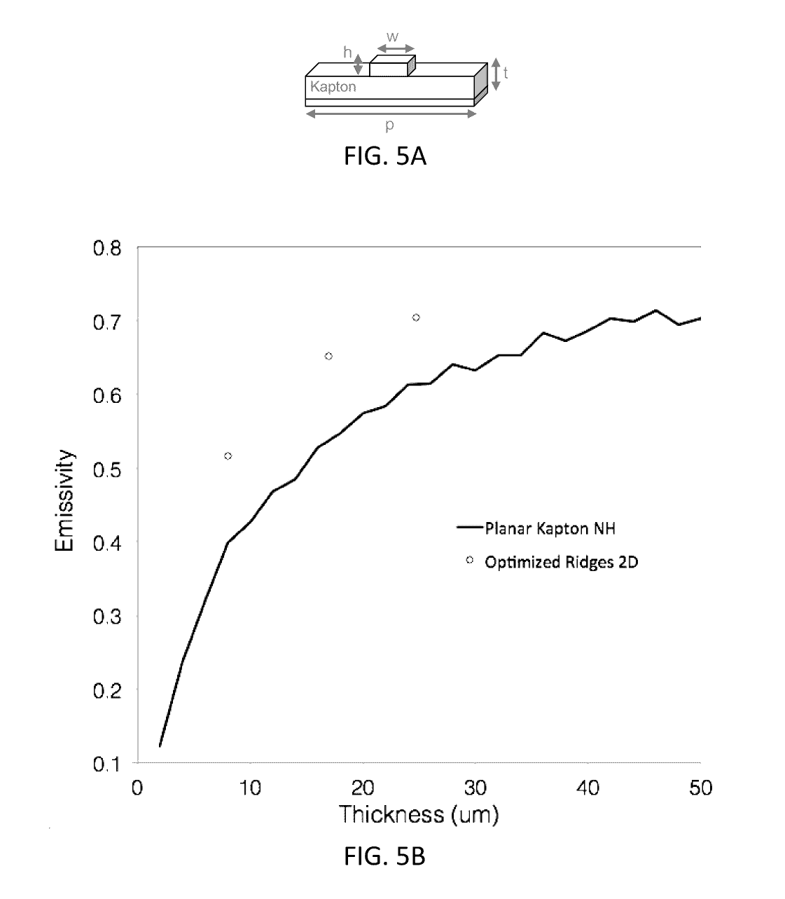

Furthermore, FIGS. 5A and 5B illustrate yet further data regarding how patterning micro features can enhance the thermal emissivity of a surface. In particular, FIG. 5A illustrates that a prism microstructure was patterned from KAPTON material, and FIG. 5B illustrates data pertaining to a KAPTON HN material. As before, each point was optimized over pitch and width. Also as before, the calculations were implemented using Rigorous Coupled Wave Analysis (RCWA). It should be noted that KAPTON B has been proven to be a particularly effective material for the disclosed application. Accordingly, in many embodiments, the microstructures are fabricated from a KAPTON B material.

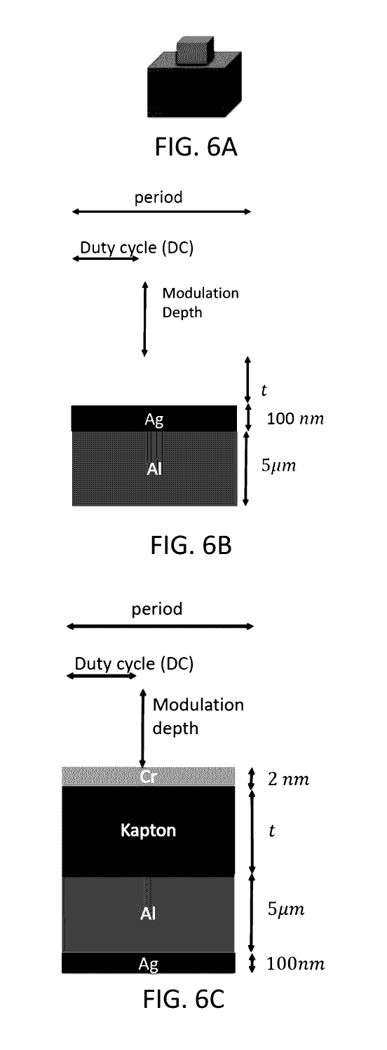

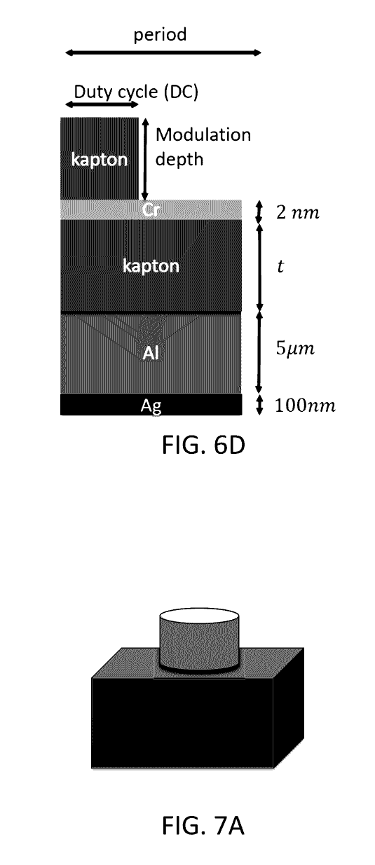

It should be emphasized that any of a variety of geometric shapes can be patterned onto a surface in accordance with many embodiments of the invention. Moreover, the shapes can be patterned in any of a variety of configurations. Thus, FIGS. 6A-8C illustrate various geometries that can be patterned onto a surface in various configurations in accordance with embodiments of the invention. For example, FIGS. 6A-6D illustrate the implementation of a rectangular prism shape that can be patterned onto a surface. More specifically, FIG. 6A illustrates an isometric view of the rectangular prism that can be implemented. FIG. 6B illustrates the patterning of a rectangular prism shape from SiO₂ onto a particular surface, as well as variables that can be manipulated in the patterning of the surface. In particular, it is depicted that the rectangular prism is patterned onto a surface including an SiO₂ layer, a 100 nm silver layer, and a 5 μm aluminum layer. Simulations indicated that with a SiO₂ layer thickness of 20 μm, a period of 10 μm and a duty cycle of 0.75 in both x and y directions assuming grid-like patterning, and a modulation depth (height of the rectangular prism) of 2.5 μm, a maximum thermal emissivity (with respect to infrared) of 87% can be obtained. Simulations also indicate that under the same conditions, except (1) a silicon dioxide thickness of 10 μm, (2) a modulation depth of 5 μm, and (3) a duty cycle of 0.5 (in both directions), a maximum thermal emissivity (with respect to infrared) of 85% can be obtained.

FIG. 6C illustrates the patterning of a rectangular shape onto a similar surface, except that the surface includes a KAPTON polyimide film in lieu of the silicon dioxide layer, and further includes a 2 nm chromium layer separating the patterned shape from the silicon dioxide layer. In this set-up, simulations indicate that a KAPTON polyimide layer thickness of 7.5 μm, a period of 10 μm and a duty cycle of 0.75 (both in the x and y directions), and a modulation depth of 2.5 μm, can yield a maximum thermal emissivity (with respect to infrared) of approximately 80%. Simulations also indicate that under the same conditions except (1) a KAPTON polyimide layer thickness of 10 μm, and (2) a modulation depth of 5 μm, a maximum thermal emissivity of approximately 83% can be achieved.

FIG. 6D illustrates a similar configuration as that seen in FIG. 6C except that the patterned shape is made from a KAPTON polyimide material. In this set-up, simulations indicate that a KAPTON polyimide layer thickness of 10 μm, a period of 10 μm and a duty cycle of 0.75 (both in the x and y directions), and a modulation depth of 2.5 μm, can yield of a maximum thermal emissivity (with respect to infrared) of approximately 79%. Simulations also indicate that under the same conditions except a modulation depth of 5 μm, the configuration can yield a maximum thermal emissivity of approximately 82%.

Relatedly, simulations have also indicated that the inclusion of a chromium layer, e.g. as depicted in FIGS. 6C and 6D, can also contribute to the enhanced thermal emissivity of the configuration. In general, the inclusion of a chromium layer that is approximately 2 nm in thickness can be particularly effective at improving thermal emissivity.

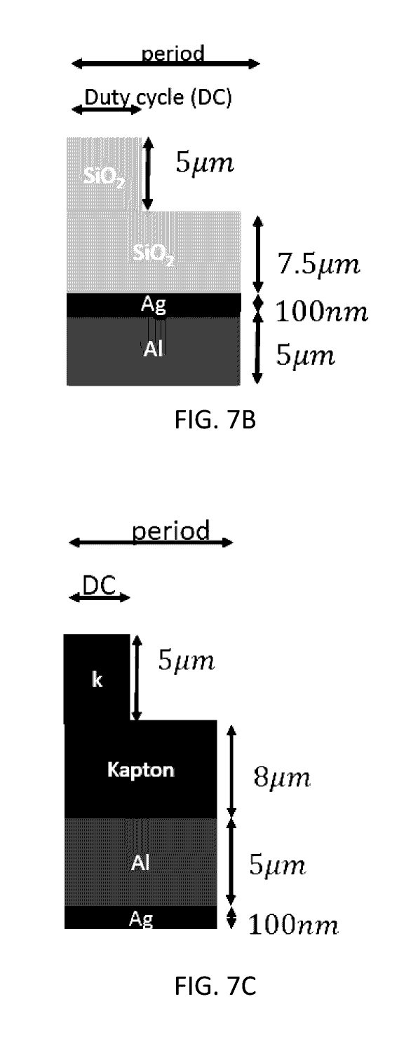

Similarly, FIGS. 7A-7C illustrate examples of a cylindrical structure patterned onto a surface in accordance with many embodiments of the invention. FIG. 7A illustrates an isometric view of a cylinder that can be patterned. FIG. 7B illustrates that the cylinder can be patterned onto a surface including SiO₂, silver, and aluminum, where the cylinder is made from SiO₂. FIG. 7C illustrates that the cylinder can be patterned onto a surface including KAPTON polyimide film, aluminum, and silver, where the cylindrical structure is made from KAPTON polyimide film. Of course, it should be appreciated that cylindrical geometries can be patterned onto any of a variety of surfaces, including any of those listed above, in accordance with embodiments of the invention.

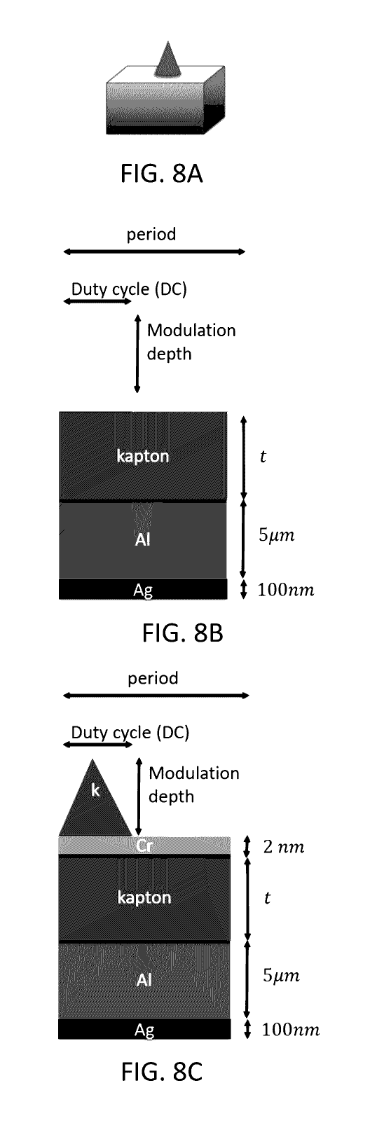

FIGS. 8A-8C illustrate examples of a conical structure patterned onto a surface in accordance with many embodiments of the invention. In particular, FIG. 8A illustrates an isometric view of a conical shape that can be implemented in accordance with embodiments of the invention. FIG. 8B illustrates that the conical shape can be patterned onto a surface including KAPTON polyimide film, aluminum, and silver, where the conical shape is made from SiO₂. FIG. 8C illustrates that the conical shape can be patterned onto a surface including chromium, KAPTON polyimide film, aluminum, and silver, where the conical shape is made from KAPTON polyimide film. While several particular geometries patterned on particular surfaces have been illustrated, it should be clear that any of a variety of geometries can be patterned on any of a variety of surfaces in accordance with embodiments of the invention. Embodiments of the invention are not specifically limited to particular shapes or particular surfaces.

With respect to FIGS. 6A-8C, simulations also indicated that the emissivity was relatively higher with a KAPTON polyimide layer thickness/silicon dioxide layer thickness of approximately between 10 μm and 20 μm.

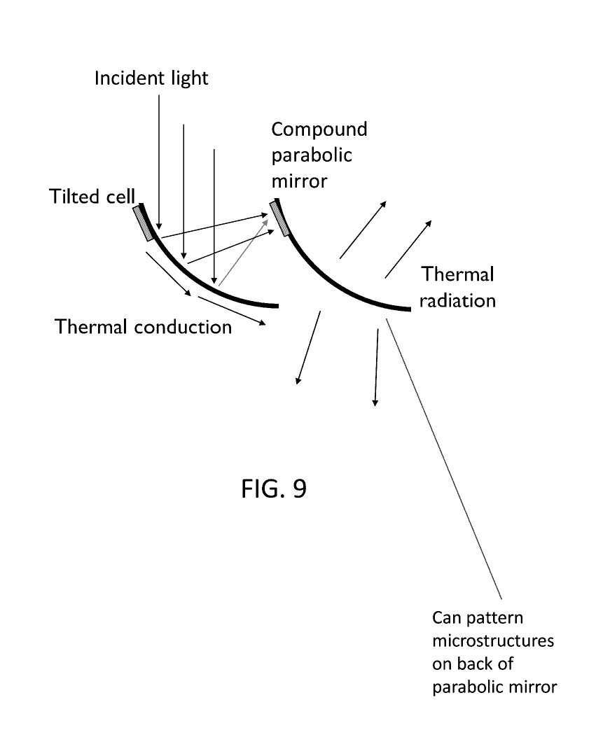

The above-described lightweight structures can be patterned onto any of a variety of structures in accordance with many embodiments of the invention, including any of a variety of space-based structures. For instance, in many embodiments, they are patterned onto aspects of a space-based solar power station. For example, FIG. 9 illustrates a suitable aspect of a space-based solar power station that the described microstructures can be patterned onto. In particular, FIG. 9 depicts parabolic mirror-photovoltaic cell combinations, and it is illustrated that microstructures can be patterned on the back of parabolic mirrors. In this way, although the mirrors may be substantially heated by the incident solar radiation, the patterned microstructures on the back of mirrors can act to increase the thermal emissivity of the surface, and thereby help cool the mirror. Additionally, since the photovoltaic cells are in thermal communication with the back of the surface of the mirror, they can also benefit from the incorporation of microstructures. In particular, heat can be thermally communicated to the microstructures, which can then thermally radiate away heat. In this way, the microstructures can help maintain suitable operating temperature for the power generation to occur.

While a particular structure has been illustrated in FIG. 9, it should be clear that the described microstructures can be implemented on any of a variety of structures, including any of a variety of structures pertaining to space-based solar power generation. For example, the disclosed structures can be used in conjunction with the systems and methods described in: U.S. provisional patent application Ser. No. 61/993,016 entitled “Large-Scale Space-Based Array: Packaging, Deployment and Stabilization of Lightweight Structures,” filed on May 14, 2014; U.S. provisional patent application Ser. No. 61/993,025 entitled “Large-Scale Space-Based Array: Multi-Scale Modular Space Power System,” filed on May 14, 2014; U.S. provisional patent application Ser. No. 61/993,957 entitled “Large-Scale Space-Based Array: Modular Phased Array Power Transmission,” filed May 15, 2014; U.S. provisional patent application Ser. No. 61/993,037 entitled “Large-Scale Space-Based Array: Space-Based Dynamic Power Distribution System,” filed May 14, 2014; U.S. provisional patent application Ser. No. 62/006,604 entitled “Large-Scale Space-Based Array: Efficient Photovoltaic Structures for Space,” filed Jun. 2, 2014; U.S. provisional patent application Ser. No. 62/120,650 entitled “Large-Scale Space-Based Array: Packaging, Deployment and Stabilization of Lightweight Structures,” filed Feb. 25, 2015; U.S. patent application Ser. No. 14/712,812 entitled “Large-Scale Space-Based Solar Power Station: Packaging, Deployment and Stabilization of Lightweight Structures,” filed May 14, 2015; U.S. patent application Ser. No. 14/712,783 entitled “Large-Scale Space-Based Solar Power Station: Multi-Scale Modular Space Power,” filed May 14, 2015; U.S. patent application Ser. No. 14/712,856 entitled “Large-Scale Space-Based Solar Power Station: Power transmission Using Steerable Beams,” filed May 14, 2015; and U.S. patent application Ser. No. 14/728,985 entitled “Large-Scale Space-Based Solar Power Station: Efficient Generation Tiles,” filed Jun. 2, 2015, all of which are incorporated by reference herein in their entirety.

To be clear, although the implementation of the microstructures has been described with respect to space-based solar power generation, it should be clear that the described microstructures can be implemented on any of a variety of structures, including any of a variety of structures configured for extraterrestrial operation, in accordance with many embodiments of the invention. Nevertheless, suitable space-based solar power generation apparatus that can benefit from the described microstructures are described below.

Suitable Space-Based Solar Power Stations that can Benefit from the Described Microstructures

A large-scale space-based solar power station that can benefit from the incorporation of microstructures in accordance with many embodiments can be a modular space-based construct that can be formed from a plurality of independent satellite modules placed into orbit within an orbital formation such that the position of each satellite module relative to each other is known. Each of the satellite modules can include a plurality of power generation tiles that capture solar radiation as electrical current and use the current to transmit the energy to one or more remote receivers using power transmitters. In many instances, the transmissions are generated using microwave power transmitters that are coordinated to act as a phased- and/or amplitude array capable of generating a steerable beam and/or focused beam that can be directed toward one or more remote receivers. In other instances, any of a variety of appropriate power transmission technologies can be utilized including (but not limited to) optical transmitters such as lasers.

In many instances, lightweight space structures used to construct the modular elements of the solar power station can benefit from the incorporation of the described microstructures. Some such lightweight space structures are used in the construction of the power generation tiles and/or satellite modules and may incorporate movable elements that allow the lightweight space structure to be compacted prior to deployment to reduce the area or dimensional length, height and/or width of the power generation tiles and/or satellite modules prior to deployment. The space structures may be made of any number, size and configuration of movable elements, and the elements may be configured to compact according to any suitable compacting mechanism or configuration, including one or two-dimensional compacting using, among others, z-folding, wrapping, rolling, fan-folding, double z-folding, Miura-ori, slip folding, wrapping, and combinations thereof. Some such movable elements are interrelated by hinges, such as, frictionless, latchable, ligament, and slippage hinges, among others. Some structures are pre-stressed and/or provided with supportive frameworks to reduce out-of-plane macro- and micro-deformation of the lightweight structures. Structures and modules may include dynamic stabilizing movement (e.g., spinning) during deployment and/or operation. Deployment mechanisms to deploy the compactible lightweight structures into a deployed operational state may be incorporated into or associated with instances of the lightweight structures. Some deployment mechanisms may include (but are not limited to) expansive boom arms, centrifugal force mechanisms such as tip masses or module self-mass, among others.

Large-scale space-based solar power stations that can benefit from the described microstructures according to many embodiments can utilize a distributed approach to capture solar radiation, and use the energy thus captured to operate power transmitters, which transmit power to one or more remote receivers (e.g., using laser or microwave emissions). The satellite modules of the solar power station can be physically independent structures, each comprising an independent array of power generation tiles. The satellite modules can each be placed into a specified flying formation within an array of such satellite modules in a suitable orbit about the Earth. The position of each of the independent satellite modules in space within the orbital array formation can be controllable via a combination of station-keeping thrusters and controlled forces from absorption, reflection, and emission of electromagnetic radiation, as well as guidance controls. Using such controllers, each of the independent satellite modules may be positioned and maintained within the controlled orbital array formation relative to each of the other satellite modules so that each satellite module forms an independent modular element of the large-scale space-based solar power station. The solar radiation received by each of the power generation tiles of each of the independent satellite module can be utilized to generate electricity, which can power one or more power transmitters on each of the power generation tiles. Collectively, the power transmitters on each of the power generation tiles can be configured as independent elements of a phased and/or amplitude-array.

The power generation tiles and/or satellite modules may also include separate electronics to process and exchange timing and control information with other power generation tiles and/or satellite modules within the large-scale space-based solar power station. In many implementations, the separate electronics form part of an integrated circuit that possesses the ability to independently determine a phase offset to apply to a reference signal based upon the position of an individual tile and/or transmitter element. In this way, coordination of a phased array of antennas can be achieved in a distributed manner.

In some instances of the distributive approach, different array elements of the phased array may be directed to transmit power with different transmission characteristics (e.g., phase) to one or more different remote power receiving collectors (e.g., ground based rectenna). Each satellite module of power generation tiles, or combinations of power generating tiles across one or more satellite modules, may thus be controlled to transmit energy to a different power receiving collector using the independent control circuitry and associated power transmitters.

A photovoltaic cell (PV) refers to an individual solar power collecting element on a power generation tile in a satellite module. The PV includes any electrical device that converts the energy of light directly into electricity by the photovoltaic effect including elements made from polysilicon and monocrystalline silicon, thin film solar cells that include amorphous silicon, CdTe and CIGS cells, multijunction cells, perovskite cells, organic/polymer cells, and various alternatives thereof.

A power transmitter or radiator refers to an individual radiative element on a power generation tile in a satellite module and its associated control circuitry. A power transmitter can include any device capable of converting power in the electrical current generated by the PV to a wireless signal, such as microwave radiation or light, including (but not limited to) a laser, a klystron, a traveling-wave tube, a gyrotron, or suitable transistor and/or diode. A power transmitter may also include suitable transmissive antennas, such as, dipole, patch, helical or spherical antennas, among others.

A phased array refers to an array of power transmitters in which the relative phases of the respective signals feeding the power transmitters are configured such that the effective radiation pattern of the power emission of the array is reinforced in a desired emission direction and suppressed in undesired directions. Phased arrays may be dynamic or fixed, active or passive.

An orbital array formation refers to any size, number or configuration of independent satellite modules being flown in formation at a desired orbit in space such that the position of the satellite modules relative to each other is known such that power generation tiles on each of the satellite modules within the formation serves as an array element in the phased array of the solar power station.

A power generation tile refers to an individual solar power collecting and transmitting element in the phased array of the large-scale space-based solar power station. In many instances a power generation tile is a modular solar radiation collector, converter and transmitter that collects solar radiation through at least one photovoltaic cell disposed on the tile, and uses the electrical current to provide power to at least one power transmitter collocated on the same tile that transmits the converted power to one or more remote power receiving collectors. Many of the power generation tiles incorporated within a space-based solar power station include separate control electronics independently control the operation of the at least one power transmitter located on the power generation tile based upon timing, position, and/or control information that may be received from other tiles and/or other modules within the largescale space-based solar power station. In this way, the separate control electronics can coordinate (in a distributed manner) the transmission characteristics of each of the power generation tiles form a phased array. Each power generation tile may also include other structures such as radiation collectors for focusing solar radiation on the photovoltaic, thermal radiators for regulating the temperature of the power generation tile, and radiation shielding, among other structures.

A satellite module refers to an array of power generation tiles collocated on a single integral space structure. The space structure of the satellite module may be a compactable structure such that the area occupied by the structure may be expanded or contracted depending on the configuration assumed. The satellite modules may include two or more power generation tiles. Each power generation tile may include at least one solar radiation collector and power transmitter. As discussed above, each of the power generation tiles may transmit power and may be independently controlled to form an array element of one or more phased arrays formed across the individual satellite module or several such satellite modules collectively. Alternatively, each of the power generation tiles collocated on a satellite module may be controlled centrally.

A lightweight space structure refers to integral structures of movably interrelated elements used in the construction of the power generation tiles and/or satellite modules that may be configurable between at least packaged and deployed positions wherein the area and or dimensions of the power generation tiles and/or satellite modules may be reduced or enlarged in at least one direction. The lightweight space structures may incorporate or be used in conjunction with deployment mechanisms providing a deploying force for urging the movable elements between deployed and compacted configurations.

A large-scale space-based solar power station or simply solar power station refers to a collection of satellite modules being flown in an orbital array formation designed to function as one or more phased arrays. The one or more phased arrays may be operated to direct the collected solar radiation to one or more power receiving collectors.

Transmission characteristics of a power generation tile refer to any characteristics or parameters of the power transmitter of the power generation tile associated with transmitting the collected solar radiation to a power receiving collector via a far-field emission. The transmission characteristics may include, among others, the phase and operational timing of the power transmitter and the amount of power transmitted.

Structure of Large-Scale Space-Based Solar Power Station that can Benefit from the Incorporation of the Described Microstructures

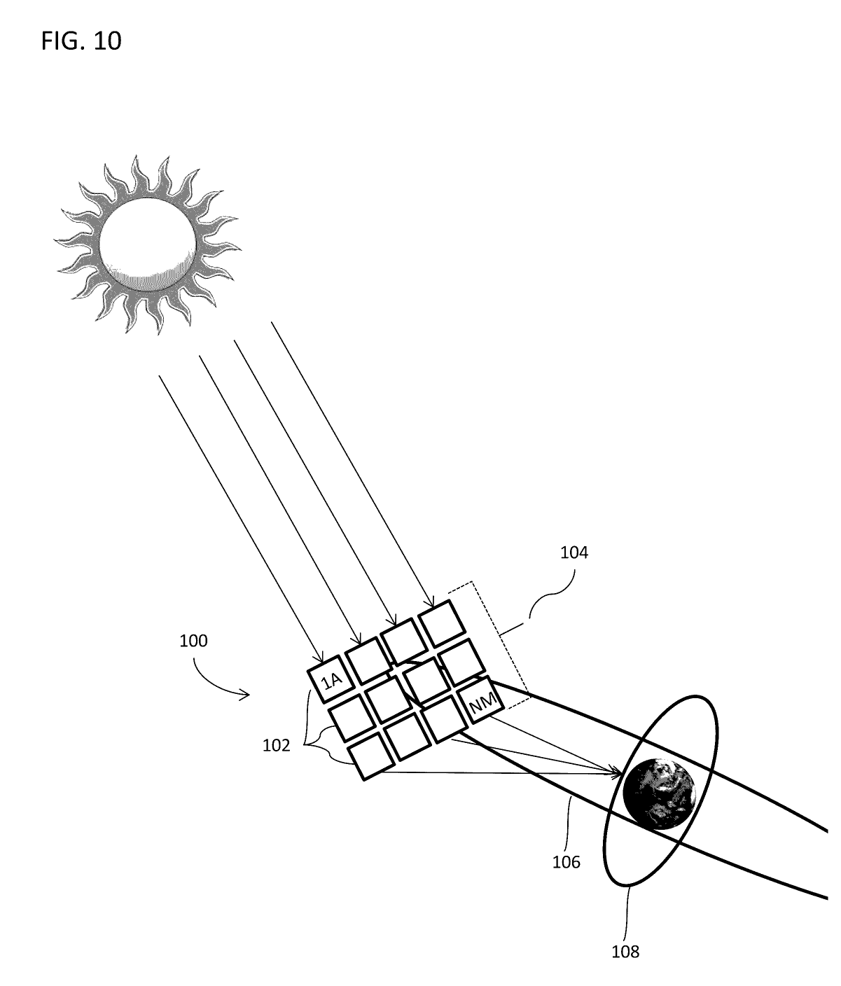

A large-scale space-based solar power station including a plurality of satellite modules positioned in an orbital array formation in a geosynchronous orbit about the Earth that can benefit from the incorporation of the described microstructures in accordance with certain embodiments of the invention is illustrated in FIG. 10. The large-scale space-based solar power station 100 includes an array of independent satellite modules 102. The solar power station 100 is configured by placing a plurality of independent satellite modules 102 into a suitable orbital trajectory in an orbital array formation 104. The solar power station 100 may include a plurality of such satellite modules 1A through NM. In one instance, the satellite modules 1A through NM are arranged in a grid format as illustrated in FIG. 10. In other instances, the satellite modules are arranged in a non-grid format. For example, the satellite modules may be arranged in a circular pattern, zigzagged pattern or scattered pattern. Likewise, the orbit may be either geosynchronous 106, which is typically at an altitude of 35,786 km above the Earth, or low Earth 108, which is typically at an altitude of from 800 to 2000 km above the Earth, depending on the application of the solar power station. As can readily be appreciated, any orbit appropriate to the requirements of a specific application can be utilized by these described space-based solar power stations.

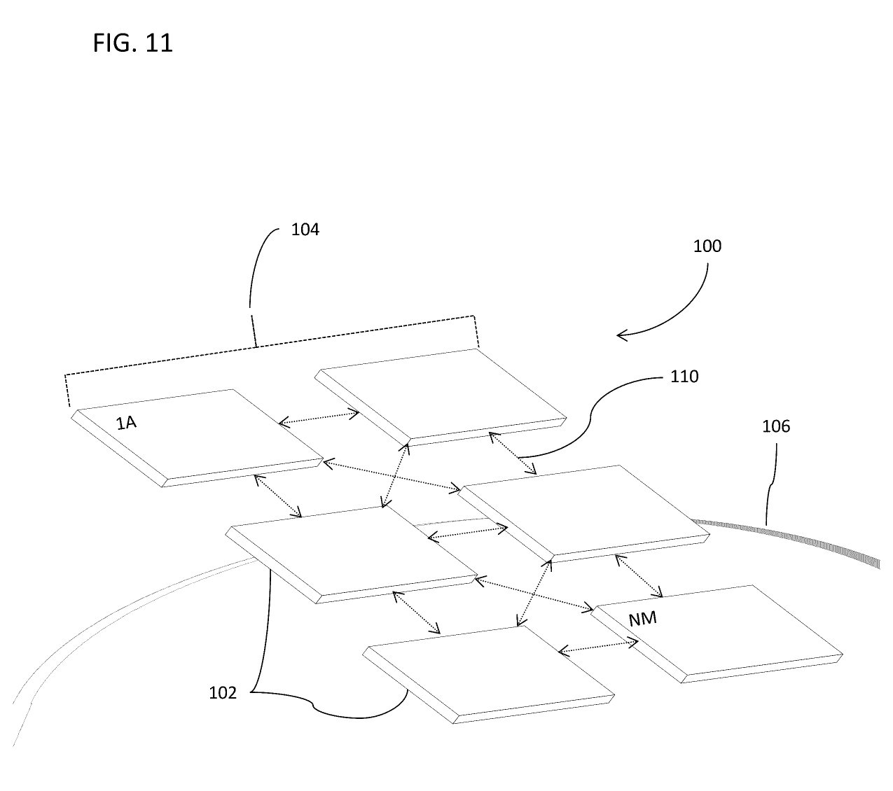

In some instances, the satellite modules in the solar power station are spatially separated from each other by a predetermined distance. By increasing the spatial separation, the maneuverability of the modules in relation to each other is simplified. As discussed further below, the separation and relative orientation of the satellite modules can impact the ability of the power generation tile on each of the satellite modules to operate as elements within a phased array. In one instance, each satellite module 1A through NM may include its own station keeping and/or maneuvering propulsion system, guidance control, and related circuitry. Specifically, as illustrated in FIG. 11, each of the satellite modules 102 of the solar power station 100 may include positioning sensors to determine the relative position 110 of the particular satellite module 1A through NM in relation to the other satellite modules 1A to NM, and guidance control circuitry and propulsion system to maintain the satellite module in a desired position within the arbitrary formation 104 of satellite modules during operation of the solar power station. Positioning sensors can include the use of external positioning data from global positions system (GPS) satellites or international ground station (IGS) network, as well as onboard devices such as inertial measurement units (e.g., gyroscopes and accelerometers), and combinations thereof. In several instances, the positioning sensors can utilize beacons that transmit information from which relative position can be determined that are located on the satellite modules and/or additional support satellites. The guidance control and propulsion system may likewise include any suitable combination of circuitry and propulsion system capable of maintaining each of the satellite modules in formation in the solar power station array 104. In many instances the propulsion system may utilize, among others, one or more of chemical rockets, such as biopropellant, solid-fuel, resistojet rockets, etc., electromagnetic thrusters, ion thrusters, electrothermal thrusters, solar sails, etc. Likewise, each of the satellite modules may also include attitudinal or orientational controls, such as, for example, reaction wheels or control moment gyroscopes, among others.

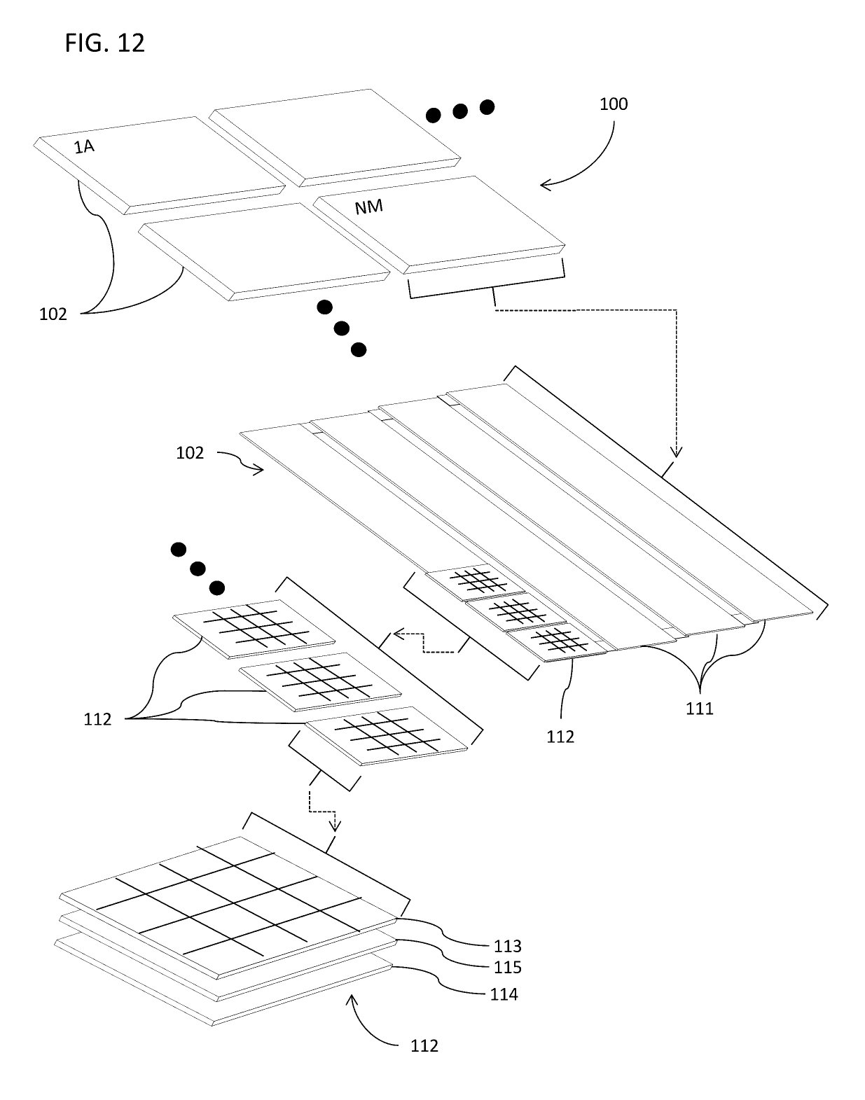

In many instances, as illustrated in FIG. 12, each satellite module 1A through NM of the solar power station 100 comprises a space structure comprised of one or more interconnected structural elements 111 having one or more power generation tiles 112 collocated thereon. Specifically, each of the satellite modules 1A through NM is associated with an array of power generation tiles 112 where each of the power generation tiles of the array each independently collect solar radiation and convert it to electric current. Power transmitters convert the electrical current to a wireless power transmission that can be received by a remote power receiving station. As discussed above, one or more power transmitters on each of a set of power generation tiles can be configured as an element in one or more phased arrays formed by collections of power generation tiles and satellite modules of the overall solar power station. In one instance, the power generation tiles in the satellite module are spatially separated from each other by a predetermined distance. In other instances, the construction of the satellite modules is such that the power generation tiles are separated by distances that can vary and the distributed coordination of the power generation tiles to form a phased array involves the control circuitry of individual power transmitters determining phase offsets based upon the relative positions of satellite modules and/or individual power generation tiles.

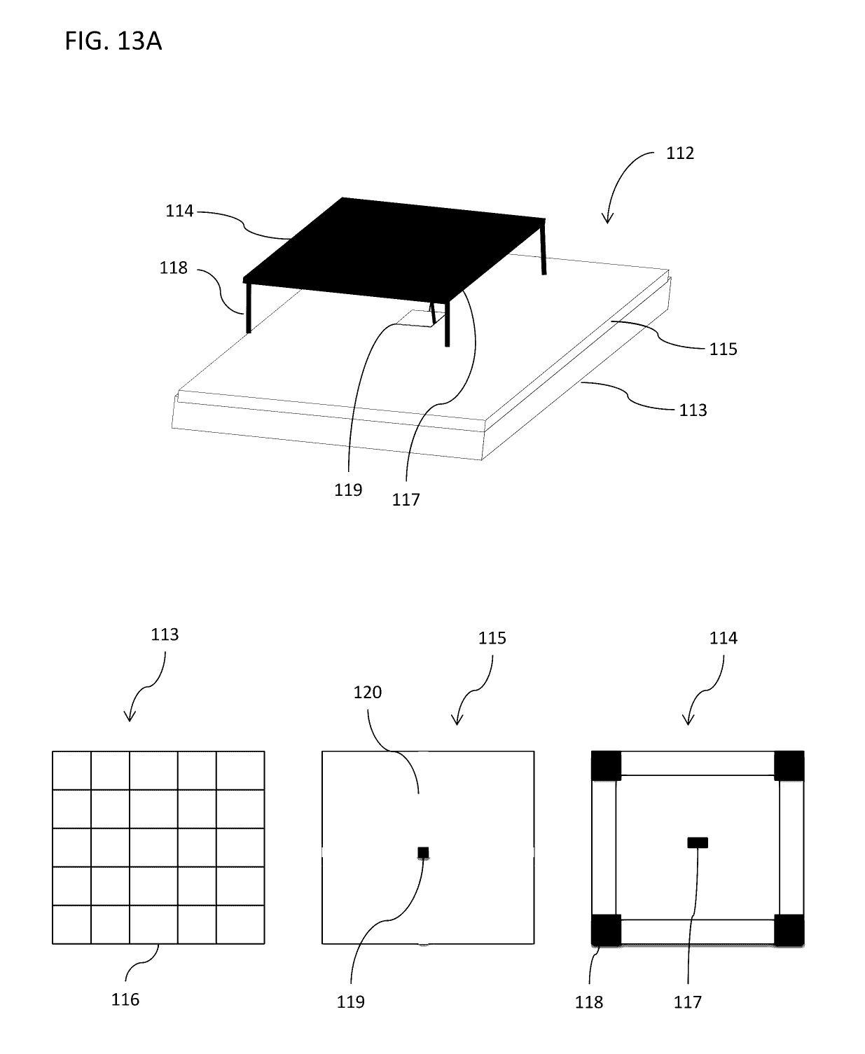

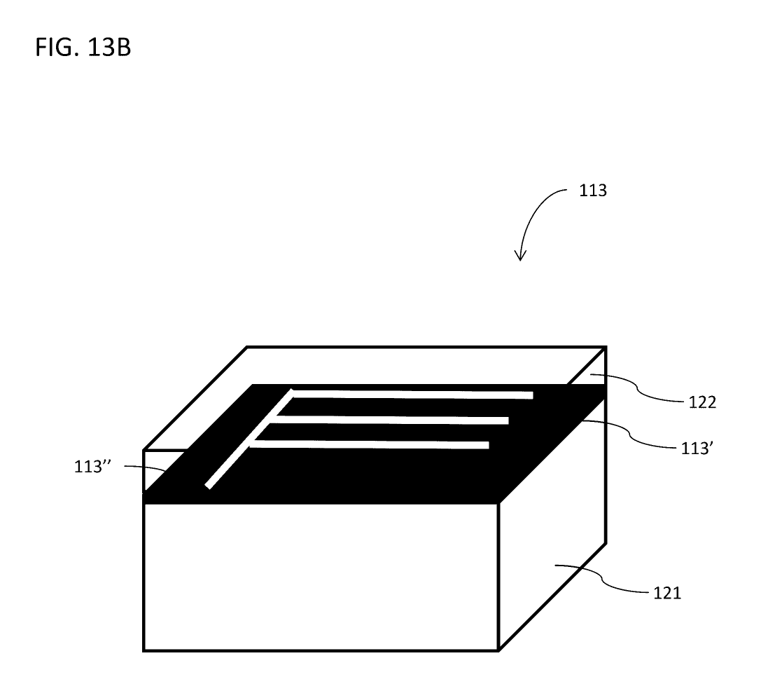

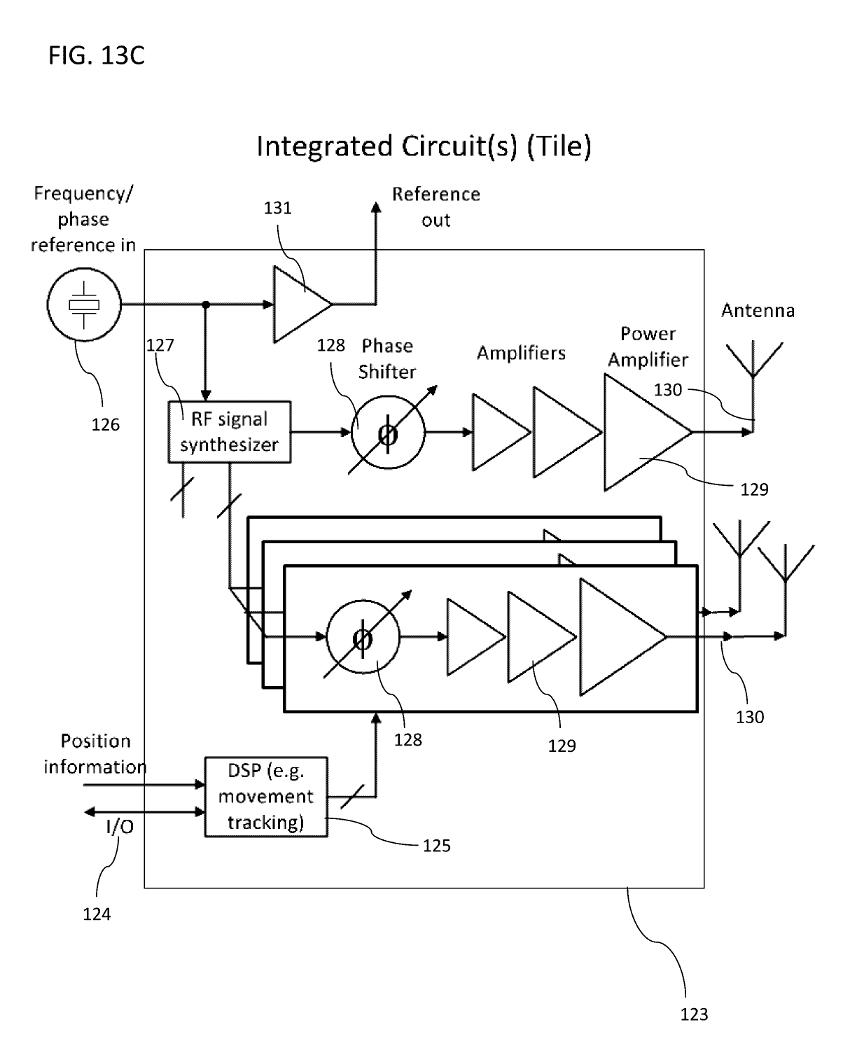

Power generation tiles 112 in many instances include a multicomponent structure including a photovoltaic cell 113, a power transmitter 114, and accompanying control electronics 115 electrically interconnected as required to suit the needs of the power transmission application. As illustrated in FIG. 13A, in some instances photovoltaic cells 113, may comprise a plurality of individual photovoltaic elements 116 of a desired solar collection area that may be interconnected together to produce a desired electrical current output across the power generation tile. Some power transmitters 114 include one or more transmission antennas, which may be of any suitable design, including, among others, dipole, helical and patch. In the illustrated instance, a conventional patch antenna 114 incorporating a conductive feed 117 to conductively interconnect the RF power from the control electronics 115 to the antenna 114. As can readily be appreciated the specific antenna design utilized is largely dependent upon the requirements of a specific application. Some power transmitters 114 are physically separated from one or both of the photovoltaic cell 113 and/or the control electronics 115 such as by fixed or deployable spacer structures 118 disposed therebetween. Some control electronics 115 may include one or more integrated circuits 119 that may control some aspect of the power conversion (e.g., to a power emission such as collimated light or an radio frequency (RF) emission such as microwave radiation), movement and/or orientation of the satellite module, inter- and intra-satellite module communications, and transmission characteristics of the power generation tile and/or satellite module. Further conductive interconnections 120 may connect the control electronics 115 to the source power of the photovoltaic cell 113. Each of the power generation tiles may also include thermal radiators to control the operating temperature of each of the power generation tiles.

In some instances, the PV 113 is a multi-layer cell, as illustrated in FIG. 13B, incorporating at least an absorber material 113′ having one or more junctions 113″ disposed between a back contact 121 on a back side of the absorber material and a top radiation shield 122 disposed on the surface of the absorber material in the direction of the incident solar radiation. The PV may include any electrical device that converts the energy of light directly into electricity by the photovoltaic effect including elements made from polysilicon and monocrystalline silicon, thin film solar cells that include amorphous silicon, CdTe and CIGS cells, multijunction cells, perovskite cells, organic/polymer cells, and various alternatives thereof. In some instances the photovoltaic material used within the PV cell is made from a thin film of GaInP/GaAs that is matched to the solar spectrum. Radiation shielding may include a solar radiation transparent material such as SiO₂ or glass, among others. The back contact may be made of any suitable conductive material such as a conductive material like aluminum, among others. The thickness of the back contact and top radiation shield may be of any thickness suitable to provide radiation shielding to the PV. Additional structures may be provided around the PV to increase the efficiency of the absorption and operation of the device including, for example, one or more concentrators that gather and focus incoming solar radiation on the PV, such as a Cassegrain, parabolic, nonparabolic, hyperbolic geometries or combinations thereof. The PV may also incorporate a temperature management device, such as a radiative heat sink. In some instances the temperature management device is integrated with the control electronics and may be configured to control the operating temperature of the PV within a range of approximately 150 K to approximately 300 K. Particularly effective configurations for power generation tiles are discussed in a subsequent section of this application.

In a number of instances, the power transmitters that are components of power generation tiles are implemented using a combination of control circuitry and one or more antennas. The control circuitry can provide the power generation tile with the computational capacity to determine the location of the power generation tile antenna(s) relative to other antennas within the satellite module and/or the solar power station. As can readily be appreciated, the relative phase of each element within a phased array is determined based upon the location of the element and a desired beam direction and/or focal point location. The control circuitry on each power generation tile can determine an appropriate phased offset to apply to a reference signal using a determined location of the power generation tile antenna(s) and beam-steering information. In certain instances, the control circuitry receives position information for the satellite module and utilizes the position information to determine the location of the power generation tile antenna(s) and determine a phase offset to apply to a reference signal. In other instances, a central processor within a satellite module can determine the locations of antennas on power generation tiles and/or phase offsets to apply and provides the location and/or phase offset information to individual power generation tiles.

In many instances, the positional information of each tile is received from partially redundant systems, such as, but not limited to, gyroscopes, accelerometers, electronic ranging radar, electronic positioning systems, phase and/or timing information from beacons, as well as employing a priori knowledge from system steering and flight control commands. In several instances, electronic systems are located on the ground, and/or in space on satellites deployed for this purpose (and, possibly, other purposes, e.g. in the case of using GPS satellites).

In a number of instances, position information may be relayed in a hierarchical fashion between modules, panels and/or tiles within the space-based solar power station, such that a central processing unit relays positional information such as location and orientation of the entire space-based solar power station with respect to a ground station and/or other suitable known locations to modules within the system. The relayed information can be expressed as an absolute and/or differential location(s), and/or orientation(s) as appropriate to the requirements of specific applications. In a similar fashion, the location and/or orientation of each module with respect to the center of the space-based solar power station or other suitable reference point can be determined at each module using processes similar to those outlined above. Furthermore, going down a hierarchical level, the position and orientation information of individual panels and tiles can be determined in a similar fashion. The entirety or any useful part of this information can be used at the tile-level, the panel-level, the module-level, the system-level and/or any combination thereof to control the phase and/or amplitude of each tile radiator to form a beam or focal spot on the ground. The aggregate computational power of the computational resources of each tile, panel and/or module can be utilized since each tile (and/or panel or module) can utilize its local computational power available from a DSP, microcontroller or other suitable computational resource to control its operation such that the system in aggregate generates the desired or close-to desired beam and/or focused transmission.

In various instances, as illustrated conceptually in FIG. 13C, power generation tile control circuitry can be implemented using one or more integrated circuits. An integrated circuit 123 can include an input/output interface 124 via which a digital signal processing block 125 can send and receive information to communicate with other elements of a satellite module, which typically includes a processor and/or memory configured by a control application. In certain instances, the digital signal processing block 125 receives location information (see discussion above) that can be utilized to determine the location of one or more antennas. In many instances, the location information can include a fixed location and/or one or more relative locations with respect to a reference point. The digital signal processing block can utilize the received location information and/or additional information obtained from any of a variety of sensors including (but not limited to) temperature sensors, accelerometers, and/or gyroscopes to determine the position of one or more antennas. Based upon the determined positions of the one or more antennas, the digital signal processing block 125 can determine a phase offset to apply to a reference signal 126 used to generate the RF signal fed to a specific antenna. In the illustrated instance, the integrated circuit 500 receives a reference signal 126, which is provided to an RF synthesizer 127 to generate an RF signal having a desired frequency. The RF signal generated by the RF synthesizer 127 is provided to one or more phase offset devices 128, which are configured to controllably phase shift the RF signal received from the RF synthesizer. The digital signal processing block 125 can generate control signals that are provided to the phase offset device(s) 128 to introduce the appropriate phase shifts based upon the determined location(s) of the one or more antennas. In many instances, the amplitude of the generated signal can be modulated and/or varied alone or in conjunction with the phase appropriately upon the determined locations to form the power beam and/or focused transmission. The amplitude can be modulated in variety of ways such as at the input of a power amplifier chain via a mixer or within an amplifier via its supply voltage, an internal gate or cascade biasing voltage. As can readily be appreciated, any of a variety of techniques appropriate to the requirements of a specific application can be utilized to amplitude modulate an RF signal. The phase shifted RF signals can then be provided to a series of amplifiers that includes a power amplifier 129. While the entire circuit is powered by the electric current generated by the PV component(s) of the power generation tile, the power amplifier is primarily responsible for converting the DC electric current into RF power that is transmitted via the RF signal. Accordingly, the power amplifier increases the amplitude of the received phase shifted RF signal and the amplified and phase shifted RF signal is provided to an output RF feed 130 connected to an antenna. In many instances, the RF signal generated by the RF synthesizer is provided to an amplifier 131 and distributed to the control circuitry of other tiles. The distribution of reference signals between tiles in a module in accordance with various instances is discussed further below.

Although specific integrated circuit implementations are described above with reference to FIG. 13C, power generation tile control circuitry can be implemented using any of a variety of integrated circuits and computing platforms in a variety of instances. Furthermore, satellite modules can be implemented without providing computational capabilities on each power generation tile and/or without utilizing the computational capabilities of a power generation tile to determine locations and/or phase shifts for the purposes of generating an RF signal to feed a power generation tile antenna.

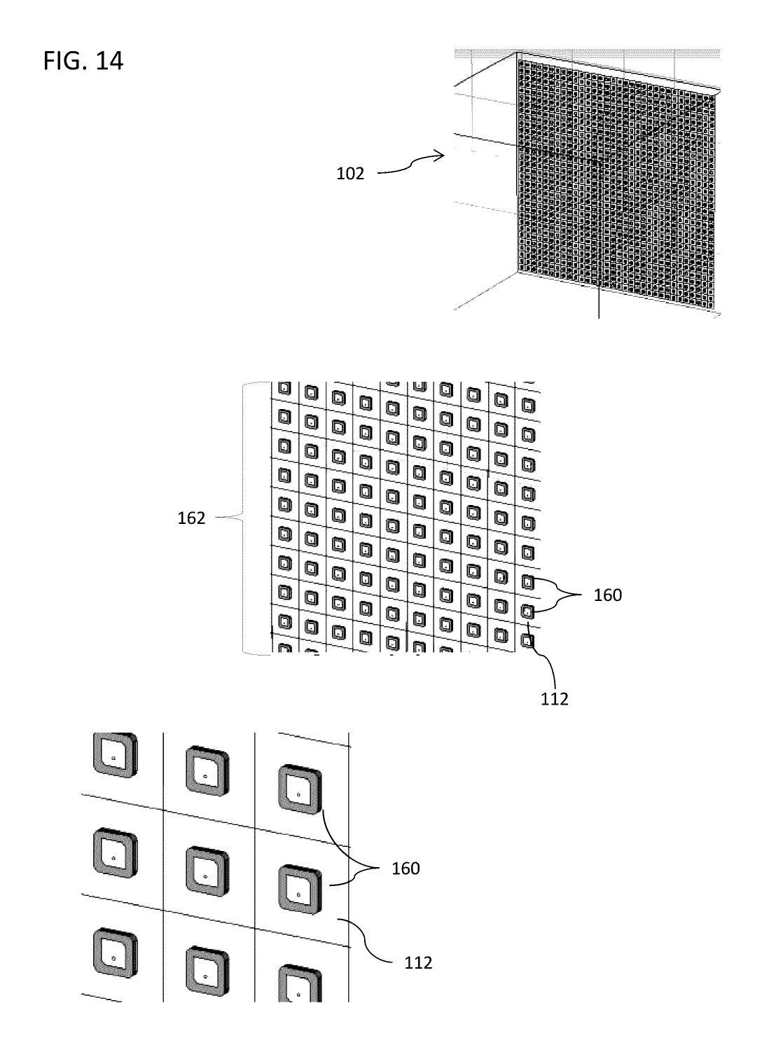

In many instances, as illustrated conceptually in FIG. 14, a plurality of power generation tiles 112 on each satellite module may each form a panel 160 of a modular phased array 162 incorporating at least self-contained, collocated photovoltaics, power transmitters and control electronics within each power generation tile. The control electronics may allow for wire or wireless communications between the individual power generation tiles for the exchange of timing and control information. The array of control electronics may also allow for the exchange of control and timing formation with other satellite modules. Collocation of at least the power collection, far-field conversion, and transmission elements on each modular power generation tile allows for the each power generation tile to operate as an independent element of the phased array without inter- and intra-module power wiring.

In one instance, the power generation tiles and/or satellite modules may include other related circuitry. The other circuitry may include, among others, circuitry to control transmission characteristics of the power generation tiles, thermal management, inter or intra-module communications, and sensors to sense physical parameters, such as orientation, position, etc. The control circuitry may control transmission parameters such as phase and timing information such that the arrays of power generation tiles across each module and across the solar power station may be operated as independent array elements of one or more phased arrays. The sensors may include gyroscopes, GPS or IGS devices to estimate position and orientation, and thermocouples to estimate the temperature on the power generation tiles.

In one instance, the circuits for controlling transmission characteristic parameters may be collocated on the several power generation tiles or satellite modules and may control each transmitter of each power generation tile independently or in a synchronized manner such that the tiles operate as one or more element of one or more phased arrays. Reference signals (e.g., phase and timing) that can be used to synchronize the operation of the power generation tiles as a phased array may be generated locally on each power generation tile or satellite module and propagated via wired or wireless intra and inter-module communications links, or may be generated centrally from a single source on a single satellite module and propagated via wired or wireless intra and/or inter-module communications links across each of the satellite modules and power generation tiles. In addition, one or multiple timing reference signals may be generated from outside the space-based solar power station system such as one or more satellites flying in close proximity or even in different orbits; as well as from one or more ground stations.

Each power generation tile or satellite module may be operated independently or collectively as an element in a phased array. Entire or most operations associated with each individual power generation tile may be collocated on each of the power generation tiles or collectivized within the satellite module on which the power generation tiles are collocated, or across multiple satellite modules. In one instance, a central reference signal is generated and deviation (e.g., phase) from such reference signal is determined for each power generation tile array element of the phased array. By propagating a central reference signal from the reference signal, higher levels of control abstraction can be achieved to facilitate simpler programming for many operations of the phased array.

In some instances, each power generation tile of each satellite module may be the same or different. The number of distinct combinations of photovoltaic cells, transmission modules and control electronics may be as large as the number of power generation tiles in the satellite modules. Further, even where each of the power generation tiles on a satellite module are the same, each of the satellite modules 1A through NM or a group of satellite modules may have different solar radiation collection or transmission characteristics or may have arrays of power generation tiles of different sizes, shapes and configurations.

In certain instances, the solar power station is designed as a modular phased array where the plurality of satellite modules and power generating tiles located thereon form the array elements of the phased array. For this purpose, each of the satellite modules may be designed to be physically compatible with conventional launch vehicles although the achieved power generation of the phased array of the solar power station may exceed conventional space-based solar power satellites in many respects. Taking advantage of the increased performance, the solar power station phased array in this case may include smaller payload size and overall array size to obtain equal or better power generation compared to conventional space-based solar power satellites. Alternatively, the size of the overall solar power station may be reduced compared to solar platforms in conventional solar power satellites while achieving comparable results.

In order to match the power generation of a conventional solar power satellite without increasing platform size or weight, the power collection, transmission and control logic for the individual power generation tiles is preferably collocated within each of the power generation tiles or within the satellite module on which the power generation tiles are collocated thus eliminating the need for intra- or inter-module communications, wiring or structural interconnection. In one instance, much of the power transmission control logic is a single collection of functions common to all or most of the power generating tiles. In this instance, the conventional external intra- and inter-power generation tile infrastructure for the solar power station may be entirely eliminated thus reducing the power generated per weight unit (W/kg).

In one instance, the phased array of the solar power station including the satellite modules and power generation tiles replaces a conventional monolithic solar power satellite. The solar power stations includes N×N satellite modules, each module including power generation tiles of

$$\frac{M}{{N}^{2}} .$$

Table 1 lists example configurations of solar power stations.

TABLE 1

| | | SPS Configuration Parameters | | | | | | |
|---|---|---|---|---|---|---|---|---|
| | | SPS | | | | Exemplary Phased Array | | |
| Efficiency Standards | | Configuration | W/kg | Max Size | | System Performance* | | |
| Solar Cell | 35% | | | | | | | |
| Efficiency | | | | | | | | |
| DC-Microwave | 78% | USEF | 41 | 100 × 95 | m | Power Received | 12 | GW |
| Conversion | | | | | | | | |
| Collection | 86% | JAXA | 98 | 3.5 | km | Power Received/ | 1.72 | MW |
| Efficiency | | | | | | Module | | |
| Transmission | 77% | ESA | 132 | 15 | km | Power Received | 1.34 | GW |
| Efficiency | | | | | | Rectenna | | |
| Atmospheric | <2% | Alpha | 33 | 6 | km | Rectenna size: | 6.65 | km |
| Absorption | | | | | | | | |
| Overall | 14% | Modular | 2270 | 60 × 60 | m | Total mass | 900000 | kg |
| | | Phased | | | | (avg: 100 g/m²) | | |
| | | Array | | | | | | |

*Assuming a Solar Power Station having a 50 × 50 array of 60 × 60 m satellite modules in a geosynchronous orbit with a 1 GHz power transmission having a a/λ = 0.5, and a solar irradiance of 1400 W/m².

The Conventional SPS performance in Table 1 are taken from published literature. The Exemplary Phased Array System Performance in Table 1 are estimates and may differ based on the actual design parameters implemented.

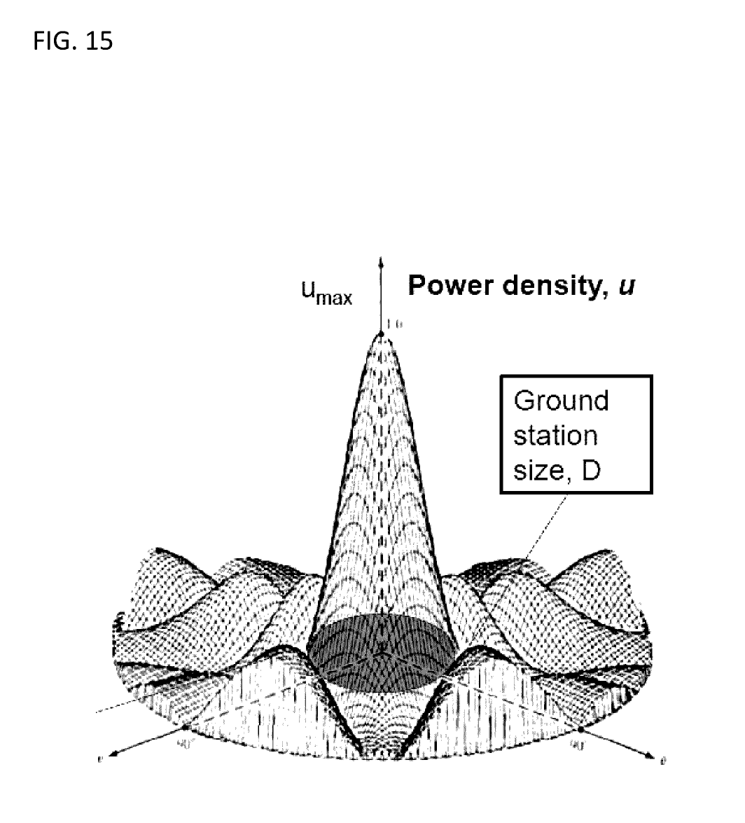

The number of power generation tile array elements in each satellite module, and the number of satellite modules in the solar power station may be determined based on, among other factors, power requirements, payload restrictions, etc. A first factor for the size of an overall solar power station is the power to be generated at the power receiving rectenna. As illustrated in FIG. 15, in certain instances, the power incident on the ground using a far-field RF emission can have a maximum power lobe (uₘₐₓ) that is dependent on factors including (but not limited to) the size of the array, the wavelength of the RF transmission, and the phase offset error tolerated within the phased array. For example, in instances of a 50×50 array of satellite modules in a solar power station formed by 60×60 m satellite modules a maximum power lobe of 926 W/m² is estimated to be generate on the ground with a sidelobe level of 44 W/m². The incident area of the maximum power lobe with a 1 GHz emission is estimated to have a diameter of 6.6 km, while the incident area is estimated to have a diameter of 2.8 km for a 2.4 GHz emission. From a power transmission point of view, the preferred number of elements in the phased array formed by a solar power station and the wavelength of the transmission will depend on the size of the receiving rectenna and/or array of receiving rectennas. In many instances it is desirable to have the maximum power lobe on the ground coextensive with the rectenna area.

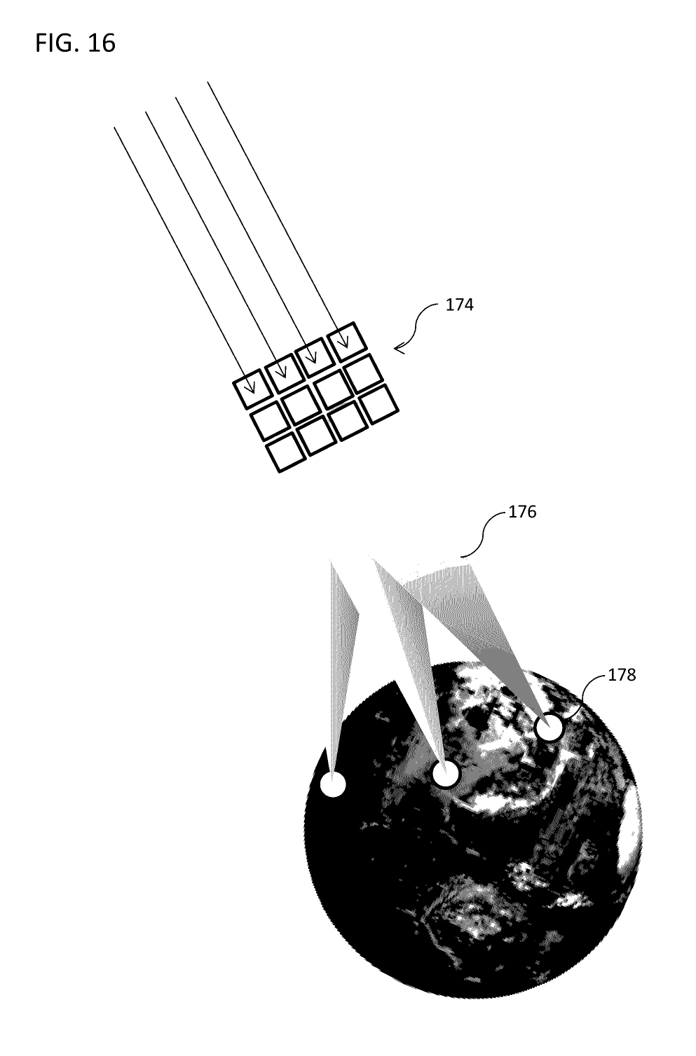

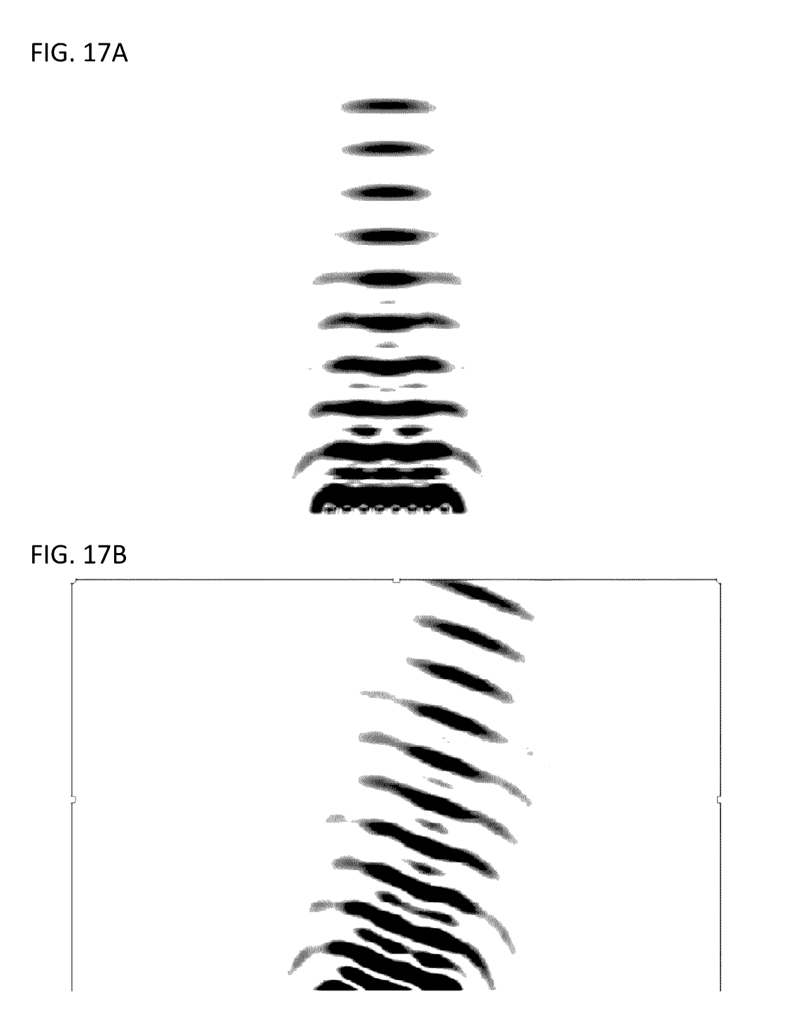

In certain instances this limitation many also be overcome by dividing the power transmission output 176 of the solar power station 174 between different rectenna power receivers 178, as illustrated conceptually in FIG. 16. In many instances, different collections of elements (e.g., satellite modules and/or power generation tiles) forming part of the solar power station 174 may be configured into different phased arrays that may be simultaneously directed at different rectenna power receivers 178 on the ground thus potentially reducing the individual incident areas radiated by the solar power station. In some instances additional control circuitry is provided either within the satellite module or within each of the power generation tiles to allow for dynamic electronic steering of the transmission beam, either from the collective power generation tiles of a satellite module or from each power generation tile independently. In some instances the power steering circuitry may allow for the control of the relative timing (phase) of the various power transmitters on the power generation tile array elements, as illustrated conceptually in FIGS. 17A and 17B, such that each transmission beam may be redirected electronically at micro- and/or nano-second time scales. The power transmission from such dynamically steerable phased array on a solar power station allows for the entire phased array or portions thereof to be dynamically redirected in different directions dependent on demand at one or more rectenna power receivers. Many instances characterized by such dynamically directable phased arrays on power solar stations may be used to redirect the power transmission in different directions at micro and nano-second time scales by electronic steering. Certain instances also allow for power transmissions to be dynamically distributed to various ground stations either simultaneously or sequentially based on instantaneous local demand. Power levels at each of such rectenna receivers may also be dynamically adjusted. Rapid time domain switching of power amongst rectenna receivers can also be used to control duty cycle and alleviate large scale AC synchronization issues with respect to an overall power grid.

A second factor that may constrain the number of array elements in any satellite module is the issue of payload size and weight. Current payload delivery technologies for geosynchronous orbits range from 2,000 to 20,000 kg. Accordingly, the limit to the size of any single satellite module is the actual lift capacity of available payload delivery vehicles. Based on an assumption of 100 g/m² for the phased array satellite modules, a 60×60 m satellite module would have a weight of 360 kg, well within the limits of current delivery technologies. Larger modules could be produced provided they are within the lift capacity of available lift vehicles.

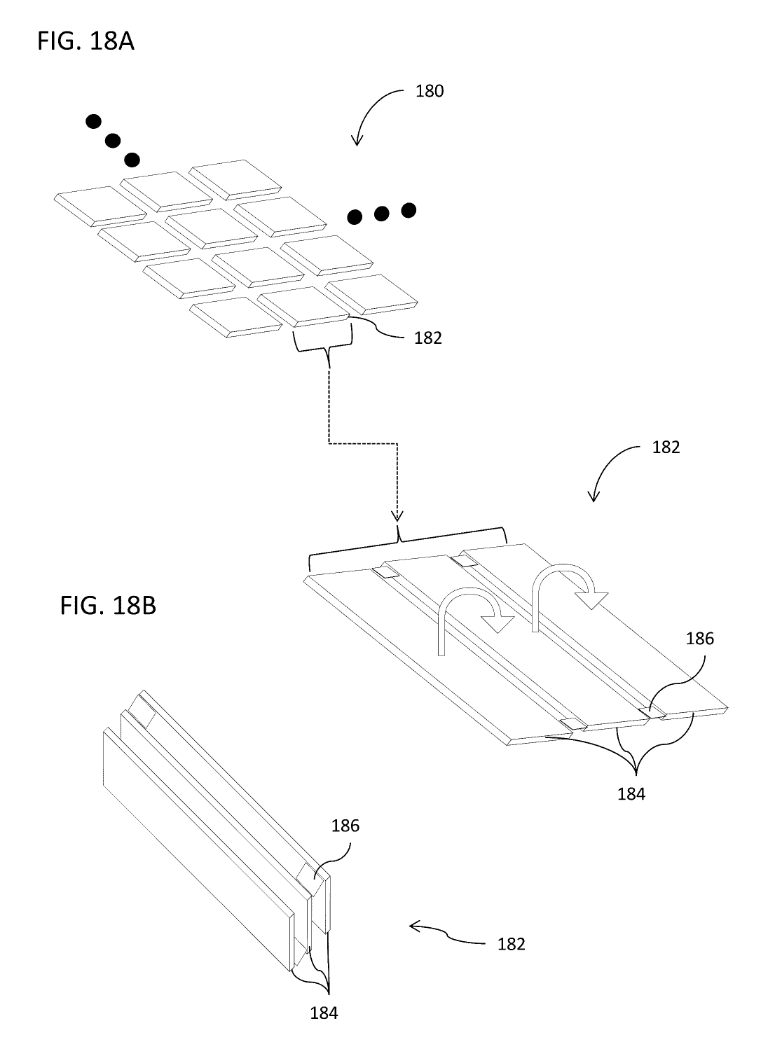

In some instances, satellite modules are compactable such that the size of the satellite module in one or more dimensions may be reduced during delivery to overcome payload space constraints and then expanded into its final operating configuration. As illustrated in FIGS. 18A and 18B, in many instances the solar power station 180 includes an array of satellite modules 182, each satellite module comprising a plurality of structural elements 184 that are movably interconnected such that the plurality of structural elements may be moved between at least two configurations: a deployed configuration (FIG. 18A) and a compacted configuration (FIG. 18B), such that the ratio of the packaged volume to the material volume is larger in the deployed configuration when compared to the compacted or packaged configuration. In some instances, the structural elements 184 may be hinged, tessellated, folded or otherwise interconnected 186 such that the structural elements can move in relation to each other between the compacted and deployed configurations. Each satellite module of a solar power station may be configured to compact to the same or different sizes. In addition, different compacting methods may be used to compact one or more satellite modules of a solar space station, including, among others, one and two-dimensional compaction structures. In some instances, one or a combination of z-folding, wrapping, rolling, fanfolding, double z-folding, Miura-ori, slip folding and symmetric wrapping may be used, among others.

In many instances the power generation tiles may have further compactible and expandable features and structures disposed thereon. In some instances of power generation tiles the photovoltaic cell and power transmitter may be movably interrelated through a compactable structure, such that when in a compacted or packaged configuration the elements of the power generating cell are compressed together to occupy a total volume lower than when in a deployed configuration. In some deployed configurations the photovoltaic cell and power transmitter are separated by a gap (e.g., to create a vertical offset therebetween). Certain instances having a compactable structure include motorized interconnections and resilient members such as spring or tension arms that are bent or under compression, among others. Such compactable structures may also incorporate packaging techniques such as one or a combination of z-folding, wrapping, rolling, fan-folding, double z-folding, Miura-ori, slip folding and symmetric wrapping may be used, among others.

The power generation tiles and/or satellite modules may include other structures to enhance the collection of solar radiation or transmission of power from the power generation tiles and/or satellite modules. Structures that may be incorporated into power generation tiles and/or satellite modules may include, among others, thermal radiators for controlling the thermal profile of the power generation tiles, light-collecting structures (e.g., radiators, reflectors and collectors) to enhance the efficiency of solar radiation collection to the photovoltaic cell, and radiation shielding to protect the photovoltaic cells, power transmitters and/or control electronics from space radiation. Such structures may also be independently compactible, between packaged and deployed configurations, as described above in relation to other elements of the power generation tiles.

A design for a satellite module or power generation tile may be applied to different satellite modules or power generation tiles. Other variables in the solar power station such as spatial distances, photovoltaics, power transmitter, control electronics and combinations with may be modified to produce a phased array with differing power collection and transmission characteristics. In this way, a diverse mix of solar power stations may be produced while maintaining the benefits of the modular solar power station described.

Compactable Space Structures that can Benefit from the Incorporation of Microstructures

In many instances, the satellite modules of the solar power station employ compactible structures which can benefit from the incorporation of microstructures in accordance with certain embodiments of the invention. Compactable structures allow for the satellite modules and/or power generation tiles to be packaged in a compacted form such that the volume occupied by the satellite module and/or power generation tiles can be reduced along at least dimension to allow for the satellite modules to fit within an assigned payload envelope within a delivery vehicle. Several exemplary instances of possible packaging schemes are provided, however, it should be understood that the packaging procedure and compactible structures may involve, among other procedures, using one and two-dimensional compaction techniques, including, one or a combination of z-folding, wrapping, rolling, fan-folding, double z-folding, Miura-ori, star folding, slip folding and wrapping.

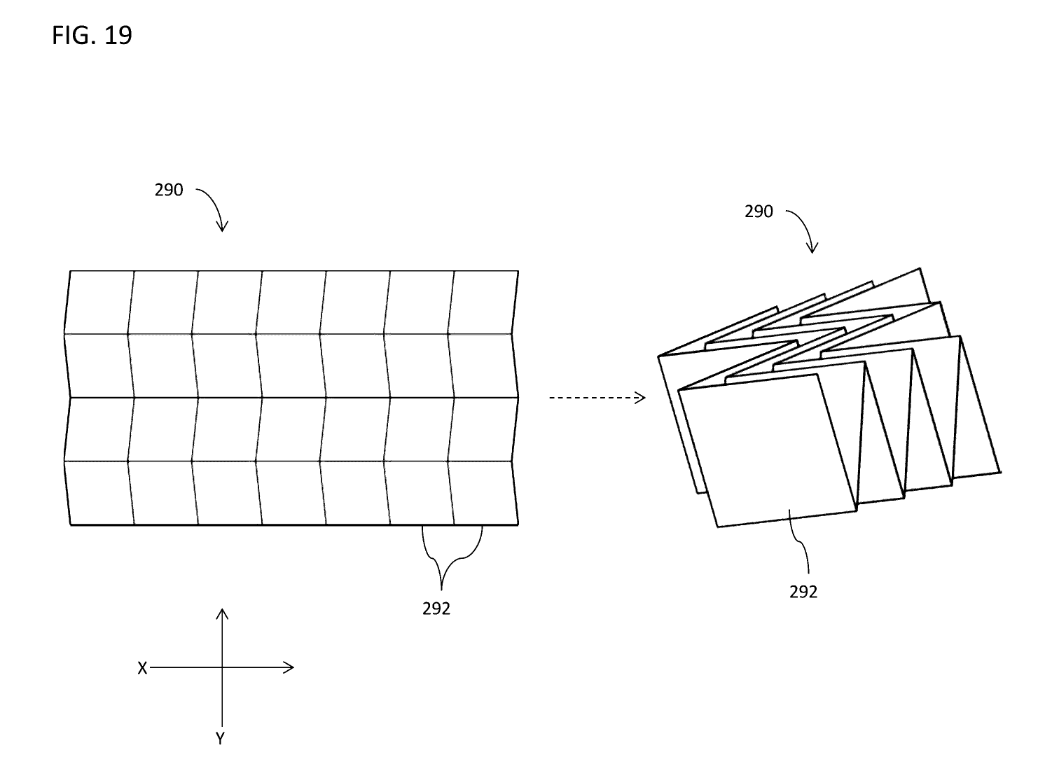

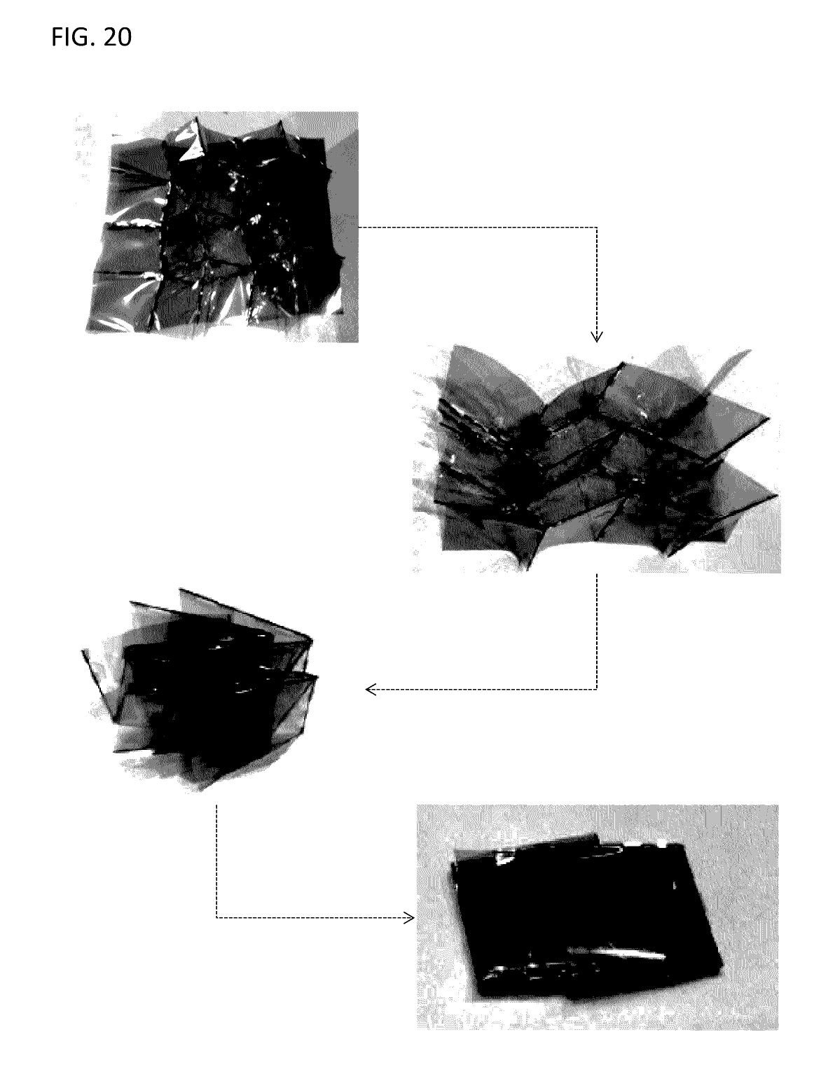

In many instances a two-dimensional compacting technique may be utilized to package and deploy the satellite modules and/or power generation tiles. FIG. 19 provides a perspective view of a satellite module 290 with a plurality of power generation tiles 292. The plurality of power generation tiles 292 in this instance are hinged together and tessellated into a Miura-ori folding pattern such that the satellite module is compacted biaxially along an X and Y axis. Although the hinges interconnecting the panels may be made of any suitable design, in one instance the hinged elements are interconnected by carbon fiber rods or other suitable support structure. Images of a membrane being folded are provided in FIG. 20.

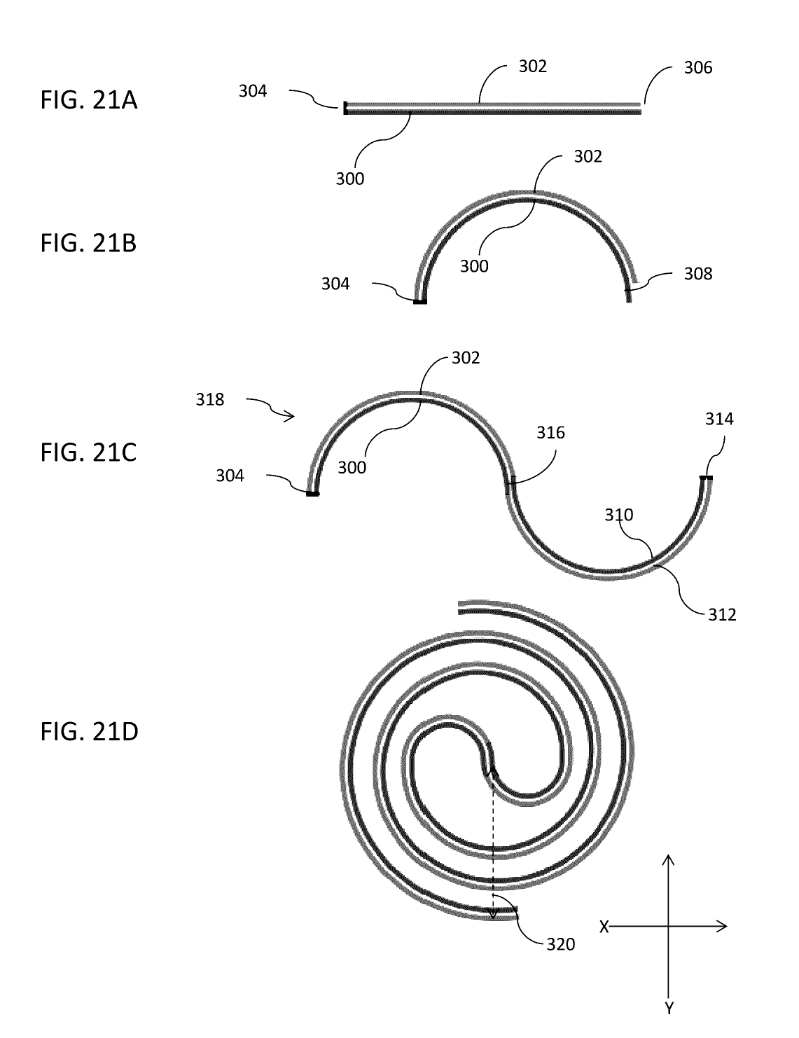

In many instances a slip-wrapping compacting technique may be utilized to package and deploy the satellite modules and/or power generation tiles. FIGS. 21A-21D provide cross-sectional views of the construction of instances of the slip-wrapping technique. As shown, in these instances two elongated elements 300 and 302 interconnected at a first end 304 and open at a second end 306 (FIG. 21A) are wrapped about a hub (FIG. 21B). Such wrapping causes one of the elongated elements 300 to slip along its longitudinal length with respect to the second elongated element 302 such that a gap 308 forms between the unconnected ends of the elements. A second set of such elongated elements 310 and 312 interconnected at one end 314 are then obtained by a 180° rotation of the first set of elongated elements and the non-interconnected ends are then joined together 316 to form a single elongated element of an undulating configuration 318 interconnected at both ends 304 and 314 (FIG. 21C). The undulating strip thus formed may then be wrapped about a hub of a specified radius 320 that is no smaller than the minimum bend radius of the material of the elongated element thus reducing the dimensions of the satellite module biaxially in both an X and a Y axis (FIG. 21D).

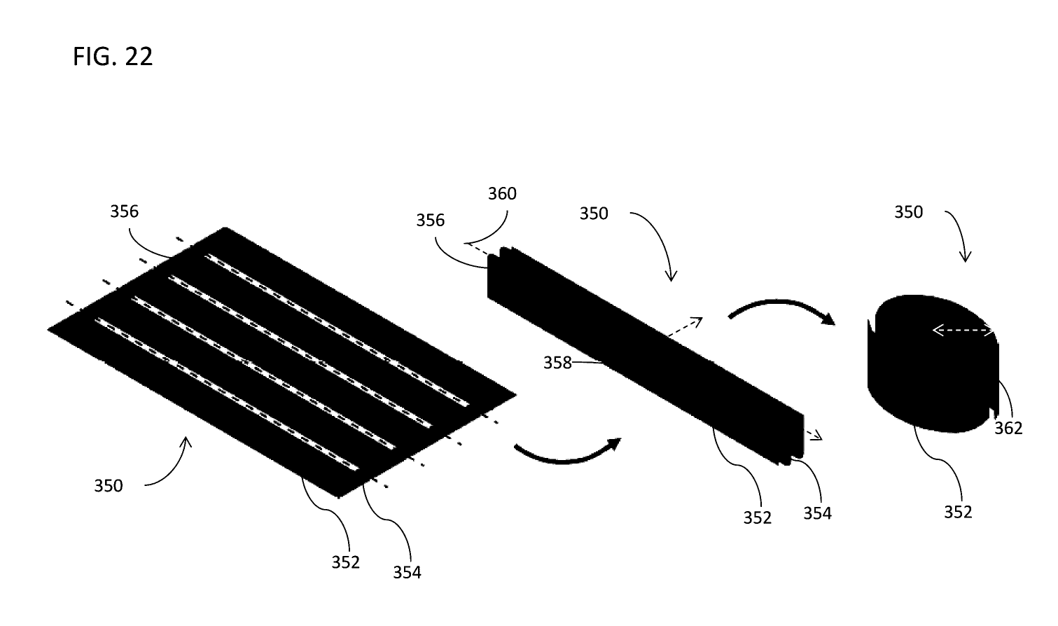

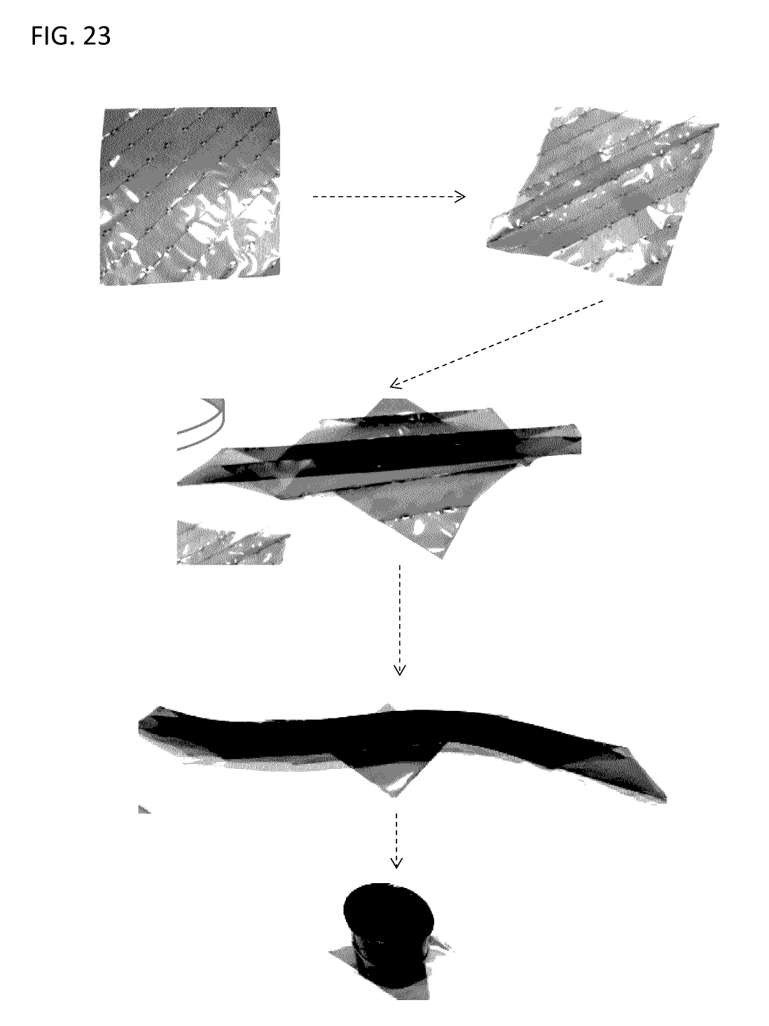

Some instances of a slip-wrap packing technique as applied to a compactible satellite module 350 are shown in a perspective view in FIG. 22. In one instance the satellite module is formed of a plurality of elongated structures 352 that are interconnected at two ends 354 and 356, but that are allowed to shear along their edges. During packaging the elongated structures are first folded with z-fold to form an elongated plurality of structures that are compacted along a first axis 358 orthogonal to the longitudinal axis 360 of the elongated structures. The compacted elongated structures are then wrapped about a hub with a radius 362 (which is selected to be no smaller than the minimum bend radius of the elongated structures of the satellite module) to further compact the strips along a second axis, thereby forming a fully compacted satellite module. Although a satellite module with an overall rectangular configuration are shown in FIGS. 19-23, it should be understood that the technique may be implemented with any configuration, number or shape of individual strip elements so long as they are joined at the edges and the edges are permitted to shear as described above. Images of a compactible structure using a diagonal z-fold are provided in FIG. 23. The deployed square of 0.5 m may be packaged into a cylindrical structure with a diameter of 10 cm and a height of 7 cm.

Using such techniques it is possible to significantly reduce the packaging volume of the satellite modules. In one exemplary instance where the compactible structures of a satellite module have a tile/panel thickness of 1 cm and a minimum bend radius of 10 cm, a satellite module with a deployed area of 60 m×60 m and being comprised of 30 such compactible structures would be compactible using the slip-wrap packaging technique into cylindrical package with a diameter of 5 m and a height of 2 m.

In many instances, the number of compactible elements in each of the satellite modules in a solar space station may be the same or different and may contain one or more power generation tiles collocated thereon. One or more compacting techniques may be used in packaging the compactible elements of each of the satellite modules and the techniques use may also the same or different. In many instances the compacting techniques utilized to package the satellite modules prior to deployment reduce the packaging volume of the satellite module in at least one dimension such that the satellite module fits within the allowed payload volume of the selected delivery vehicle.

In many instances, the power generation tiles may have further compactible and expandable features and structures disposed thereon. In some instances, power generation tiles, the photovoltaic cell, and power transmitter may be movably interrelated through a compactable structure, such that when in a compacted or packaged configuration the elements of the power generation tile are compressed together to occupy a total volume lower than when in a deployed configuration. In some deployed configurations the photovoltaic cell and power transmitter are separated by a gap (e.g., to create a vertical offset therebetween). Some instances of compactable structure include motorized interconnections and resilient members such as spring or tension arms that are bent or under compression, among others. Such compactable structures may also incorporate packaging techniques such as one or a combination of z-folding, wrapping, rolling, fan-folding, double z-folding, Miura-ori, slip folding and symmetric wrapping may be used, among others.

In many instances, deployment mechanisms are provided to deploy the compacted satellite modules (e.g., move the compactible elements of the satellite module from a compacted to a deployed configuration). In many instances, an active or passive mechanism is interconnected with one or more portions of the compactible structures of the satellite module such that when activated the compacted structures of the satellite modules may be expanded into a deployed operational configuration.

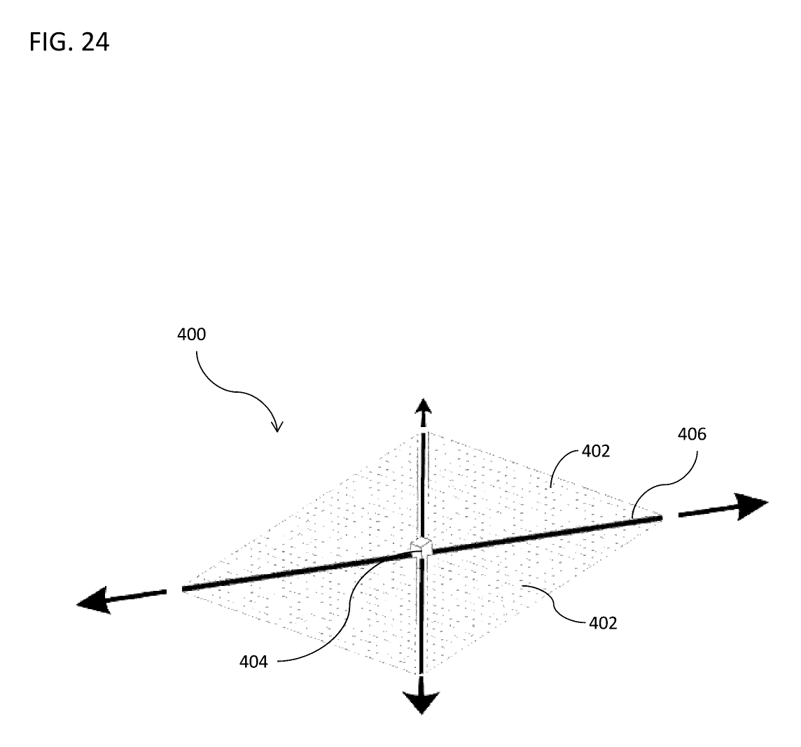

In some instances, a mechanically expandable member may be incorporated into the satellite module. An illustration of such a satellite module is provided in FIG. 24 where a satellite module 400 having a plurality of compactible structures 402 are disposed about a central hub 404. The compactible structures 402 are interconnected on at least one edge with a mechanically expandable member 406 such that as the mechanical member is urged outward the compactible structures are also expanded outward from the central hub. The expandable member may be motorized or may use stored energy, such as, compressed or bent expandable members, among others.

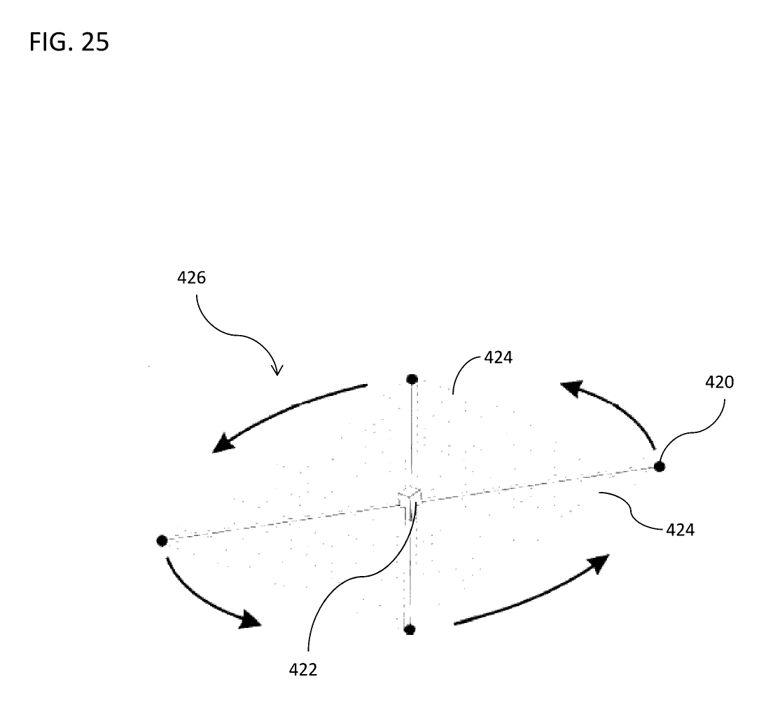

In many instances the compactible structures of the satellite module may be configured such that motion of the satellite module provides the expansive deployable force. An illustration of one such instance is provided in FIG. 25 where weighted elements 420 are attached between a central hub 422 and at least a portion of each of the compactible structures 424 of the satellite module 426 such that when the central hub of the satellite module is spun the centrifugal force of the spinning hub causes the weighted elements to move outward thereby expanding the compactible structures. In such instances, the satellite module may be made to spin continuously to provide a stabilization force to the compactible structures.

Regardless of the mechanism chosen, in many instances, the satellite module may be divided into any number and configuration of separate compactible structures with any number of hubs and deployment mechanisms (e.g., expandable members, weighted elements, etc.). In many instances, the compactible structures are attached along at least two edges to more than one deployment mechanism such that more even expansion of the compactible structures may be obtained. In many instances, for example, multiple weights or expandable members may be attached to each of the compactible structures along multiple points or edges of the compactible structures. Some expandable members or weighted elements may be incorporated into the structure of the compactible structures. Many instances of deployment mechanisms may include deployment controls to controllably operate the compactible structures of the satellite modules so that the satellite modules are expanded into a deployed configuration when desired. Some instances of such deployment controls may be automated, such that the positioning or motion of the satellite hub automatically engages the deployment mechanism, such as, for example, by spinning the satellite module at a specified rate. Other instances may incorporate control circuits such that an external signal or command is required to activate the deployment mechanism. Such deployment controls may operate across an entire satellite module, may be disposed individually in each power generation tile, or a combination thereof.

### Efficient Power Generation Tile Configurations

In many instances, particularly efficient power generation tiles are implemented within space-based solar power stations that can benefit from incorporating the above-described microstructures. The implementation of such power generation tiles within the described SBSP systems can make them more practicable insofar as they can offer greater power generation per unit mass. As can be appreciated, power generation tiles having a reduced mass can be advantageous for at least two reasons: (1) they can allow for reduced launch costs—i.e. a reduced payload can be cheaper to send into outer space; and (2) they can enable easier maneuverability of corresponding satellite modules. Against this backdrop, in many instances, thin film, pliable, photovoltaic materials that create an electrical current from solar radiation are implemented; the thin film photovoltaic materials can be used in conjunction with lightweight substrates for structural support. As can be appreciated, a photovoltaic material can be understood to be a contiguous material having a structure whereby the receipt of incident light (photons) excites electrons to a conduction band to a useful extent, and thereby allows for the creation of a useful electrical current. In a number of instances, concentrators are implemented that redirect solar radiation toward an associated photovoltaic material, such that the photovoltaic material can experience greater solar flux relative to the case where no concentrators are used. As can be appreciated, the amount of electrical current that a corresponding PV cell is able to produce is directly related to the incident solar radiation (accounting for its concentration/flux). In this way, for a given target power generation value, the utilization of concentrators can allow the amount of photovoltaic materials used, along with respective attendant radiative shielding (which can be relatively massive), to be reduced. In several instances, configurations are implemented that facilitate the radiative cooling of the photovoltaic materials, which can allow them to generate power more efficiently. For example, as can be appreciated from the above description, in many embodiments, structures that are sized approximately on the order of wavelengths of thermally radiated light and are otherwise configured to effectively increase the emissivity of the of power generation tiles, and thereby contribute to the radiative cooling of the photovoltaic materials, are implemented.

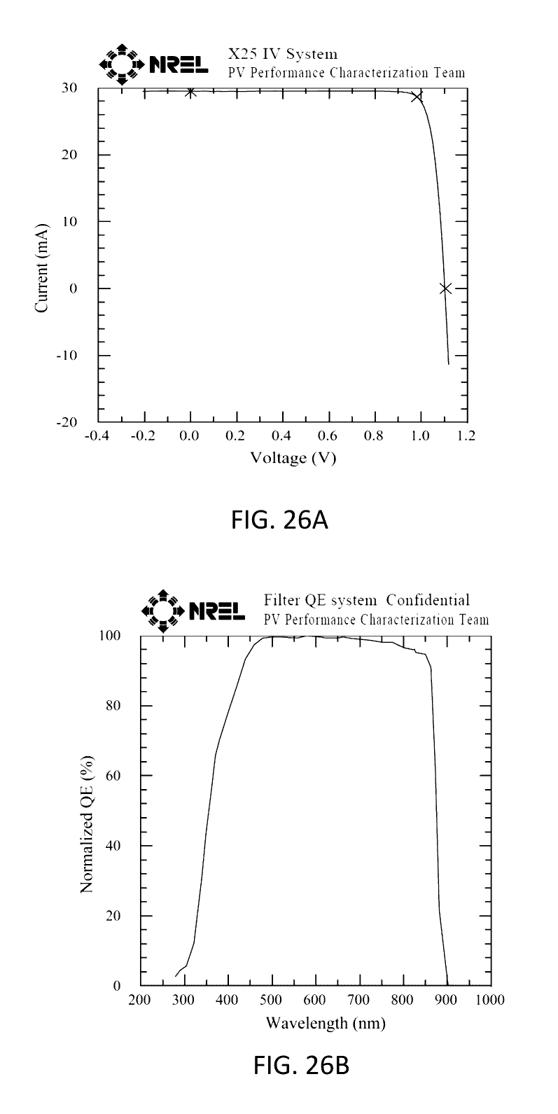

In many instances, a thin film photovoltaic material is implemented, such as those used in a typical III-V solar cell, to produce electrical current from incident solar radiation. Thus, for instance, in many instances, a Gallium Arsenide thin film photovoltaic material is implemented, such as those developed by ALTADEVICES. FIGS. 26A and 26B illustrate performance data pertaining an ALTADEVICES photovoltaic material that can be incorporated in accordance with certain instances. In particular, FIG. 26A depicts the current vs. voltage characteristics of an X25 IV System, while FIG. 26B depicts a normalized QE performance as a function of electromagnetic wavelength. ALTADEVICES thin film photovoltaic materials have demonstrated efficiencies as high as: 28.8% for a single junction configuration; 31% for a dual junction configuration; and 36% for a triple junction configuration. As can be appreciated, multijunction PV cells can produce electric current for a broader range of electromagnetic wavelengths, and can thereby demonstrate greater conversion efficiencies. Note that this data was obtained under conditions of 1 Sun and 1.5 atmospheric G. Of course, it should be realized that, while the implementation of ALTADEVICES photovoltaic materials has been discussed, any suitable photovoltaic materials can be incorporated in a variety of instances. In other words, the described instances are not constrained to the implementation of photovoltaic materials produced by ALTADEVICES. For example, in many instances, power generation tiles include photovoltaic materials fabricated by SPECTROLABS. In a number of instances, power generation tiles include photovoltaic materials fabricated by SOLAERO TECHNOLOGIES. Any thin film photovoltaic materials that are characterized by desirable pliability and durability can be implemented.

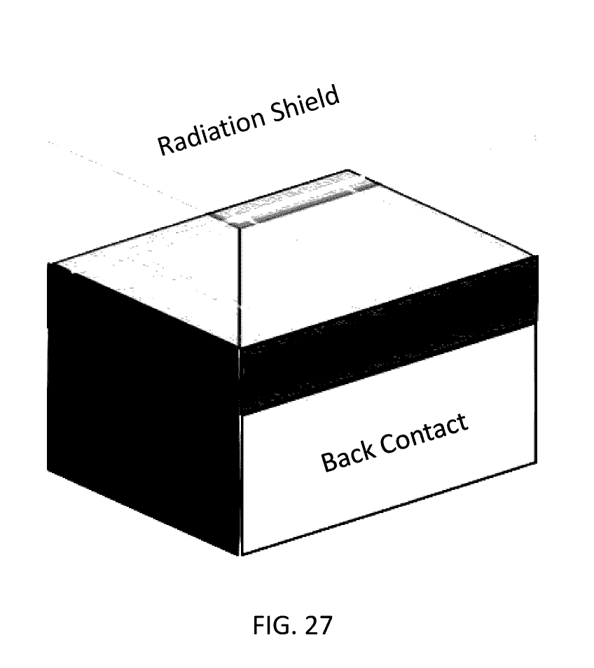

Notably, in many instances when photovoltaic materials are implemented in outer space, they are typically accompanied by radiation shields that protect them from deleterious radiation. The radiation shields are typically in the form of cover glass, which can be relatively massive. To provide context, FIG. 27 illustrates a typical configuration for a PV cell that is to be implemented in outer space. In particular, FIG. 27 depicts that a typical configuration for a PV cell includes a photovoltaic material disposed on a back contact and covered by a radiation shield. Note that it is typical for the entire surface area of a photovoltaic material to be protected by radiation shielding. Thus, implementing photovoltaic materials having relatively more surface area generally involves implementing correspondingly more radiation shielding. As radiation shielding (commonly in the form of cover glass) can be relatively massive, including more radiation shielding can non-negligibly increase the mass of the power generation tile, which can be undesirable. Accordingly, many instances implement configurations that reduce the amount of radiation shielding, while preserving power generation efficiency. For example, in many instances, concentrators are incorporated that can reduce the amount of photovoltaic material required for a target power generation value. In effect, the amount of photovoltaic cell surface area is reduced by relatively less massive concentrators.

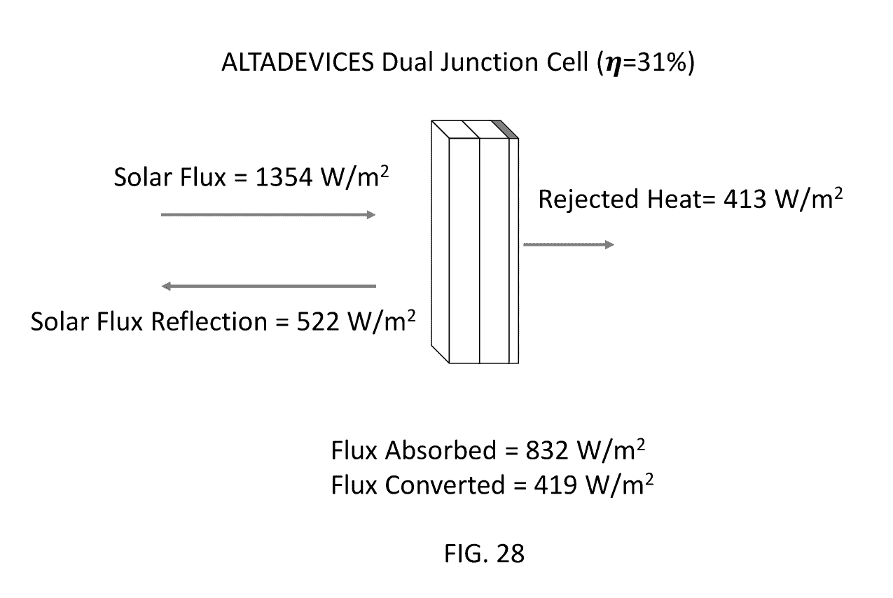

Moreover, in many instances power generation tile configurations are implemented that facilitate the cooling of the photovoltaic materials, e.g. by using the above-described microstructures. As can be appreciated, photovoltaic materials can heat up extensively during operation, and heat can adversely impact a photovoltaic material's ability to produce electrical current. To provide context, an energy balance for a sample solar cell in operation is depicted in FIG. 28. In particular, an ALTADEVICES Dual Junction Cell having a conversion efficiency of 31% is illustrated. The Dual Junction Cell experiences a solar flux of 1354 W/m², of which 522 W/m² is reflected. Correspondingly, 832 W/m² is absorbed by the Dual Junction Cell, of which 419 W/m² is converted into electrical energy, and 413 W/m² of which is rejected as heat. In general, the rejection of heat reduces the operating temperature of the photovoltaic material so as to benefit its power generation efficiency.

In many instances, configurations are implemented that provide improved power generation per unit mass. For instance, in many instances concentrators are implemented that concentrate solar radiation onto a corresponding photovoltaic material such that the photovoltaic material experiences greater solar flux relative to if the photovoltaic material were subjected to unaltered solar radiation. As can be appreciated a photovoltaic material's ability to generate electrical current is related to the amount of incident solar radiation/flux. Note that concentrators can be made to be less massive than the combined mass of conventional PV cells including radiation shielding. Accordingly, the incorporation of concentrators can reduce the amount of photovoltaic material for a given desired power generation value, and can correspondingly reduce the amount of radiation shielding implemented.

The concentrators can take any suitable form in accordance with many instances. For example, in many instances, concentrators are implemented in the form of an aluminum film disposed on a KAPTON polyimide film produced by DUPONT. In several instances, the aluminum has a thickness of between approximately 2 μm and approximately 10 μm. In many instances, the KAPTON polyimide film has a thickness of approximately 10 μm. In effect, the aluminum acts as the reflective surface (i.e., a ‘reflector’), while the KAPTON polyimide film acts as a supportive substrate. Note that while several illustrative dimensions are referenced, it should be clear that the structures can adopt any suitable dimension in accordance with many instances. It should also be clear that concentrators can be implemented using any of a variety of materials, not just those recited above—e.g., reflectors and substrates can comprise any suitable material. For example, in many instances, a silver reflective surface is incorporated. The incorporation of silver can be advantageous insofar as silver has a relatively lower optical loss over that portion of the electromagnetic spectrum characterized by wavelengths of approximately 300 nm to approximately 900 nm relative to aluminum. In a number of instances, a dielectric reflector is implemented within a concentrator. The utilization of a dielectric reflector can be advantageous insofar as it can be made to not overly interfere with any desired electromagnetic transmissions (or any other transmission). For example, where the corresponding space-based solar power station is transmitting generated power via microwaves, dielectric reflective surfaces can be implemented that do not overly interfere (if at all) with the transmission. In any case, while several materials have been mentioned for the construction of concentrators, it should be clear that the concentrators can be implemented using any of a variety of suitable materials in many instances, and are not restricted to construction from the above-recited materials.

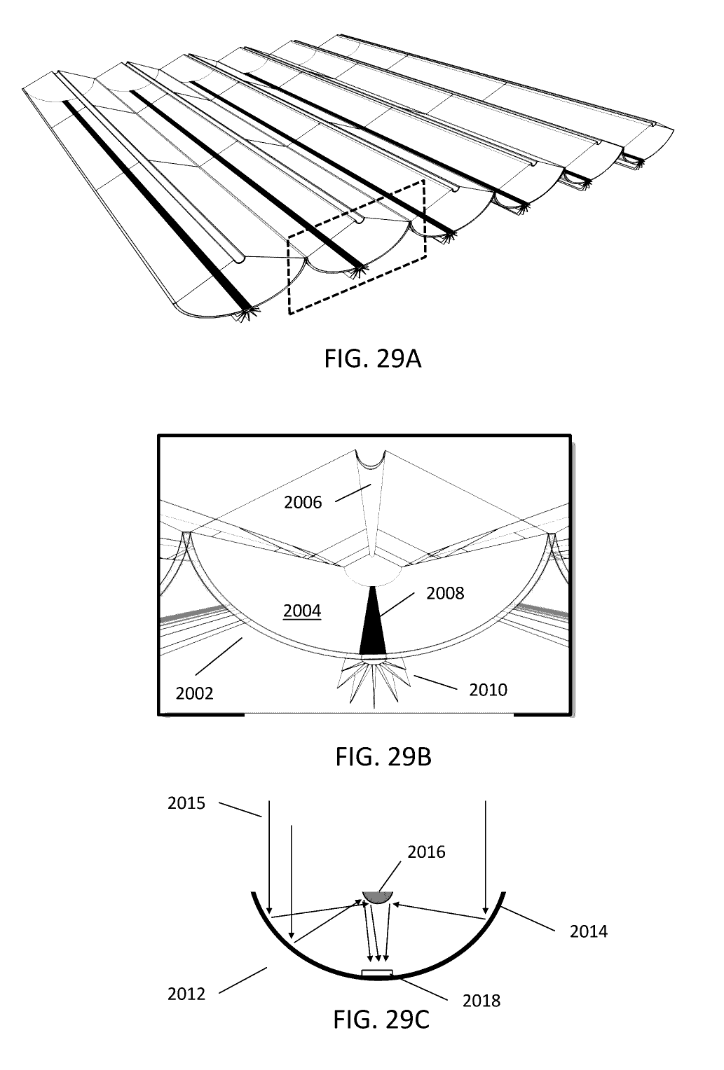

Importantly, concentrators can be implemented in any of a variety of geometric configurations. For example, in many instances, Cassegrain configurations are implemented; Cassegrain configurations are typically characterized by primary and secondary reflectors that redirect solar radiation onto a photovoltaic material (typically disposed on the primary reflector). Typically, a primary reflector redirects incident solar radiation onto a secondary reflector, which subsequently redirects incident solar radiation onto a photovoltaic material. Note that a reflector can be understood to be that portion of a concentrator which directly reflects incident solar radiation. For example, FIGS. 29A-29C illustrate a Cassegrain configuration that can be implemented. In particular, FIG. 29A depicts an isometric view of the iterative Cassegrain configuration. FIG. 29B illustrates a cross-sectional view of a single Cassegrain cell within a Cassegrain configuration. In particular, it is illustrated that the Cassegrain cell 2002 includes a primary reflector 2004, a complementary secondary reflector 2006, a photovoltaic material 2008, and a radiative heat sink 2010 that can facilitate the rejection of thermal energy by the photovoltaic material 2008. As can be appreciated from the above discussion, the reflectors can be implemented using any suitable material in a number of instances, including but not limited to aluminum, silver, and/or dielectrics. Similarly, they can be disposed on any suitable substrate, including but not limited to a KAPTON polyimide film.

FIG. 29C illustrates the generalized understanding of the operating principles of Cassegrain configurations. In particular, it is illustrated that for a Cassegrain structure 2012, it is generally understood that light rays 2015 are redirected by a primary reflector 2014 onto a secondary reflector 2016, and subsequently onto a photovoltaic material 2018. It should be clear that the described instances are not constrained to the precise manifestation of these operating principles. Rather, the understood generalized operating principles are discussed here to facilitate the understanding of the structure.

Note that the reflectors implemented in Cassegrain structures can incorporate any of a variety of complementary shapes to redirect—and focus—solar radiation onto a photovoltaic material. For example, in many instances, a primary reflector conforming to a parabolic shape is implemented, while a corresponding secondary reflector that conforms to a hyperbolic shape is implemented. Moreover, the particular characteristics of the parabolic and hyperbolic shapes can be adjusted based on the requirements of a particular application. For instance, the parabolic and hyperbolic shapes can be made to be wider or narrower based on desired design criteria. To be clear though, any suitable pairing of reflector shapes that redirect solar radiation onto a photovoltaic material can be implemented, and not just those conforming to parabolic/hyperbolic shapes.

Cassegrain structures, such as those illustrated in FIGS. 29A-29C, can be advantageous insofar as they can demonstrate good thermal properties. For example, as the photovoltaic materials are typically in direct contact with the primary reflector, the primary reflector can function has a heat sink for the photovoltaic material, and thereby facilitate radiative cooling. As the primary reflector can facilitate conductive cooling, it can be said to be in thermal communication with the photovoltaic material. Additionally, dedicated heat sinks can also be coupled to the photovoltaic material, as illustrated in FIG. 29B. As can be appreciated, coupled heat sink structures can further assist the photovoltaic material in tending towards cooler, more preferable (e.g. efficient), operating temperatures.

While Cassegrain structures can exhibit advantageous thermal properties, they can be sensitive to solar radiation angle of incidence. For example, the secondary reflector can cast a shadow and thereby hinder solar flux received by the primary reflector, and eventually the photovoltaic material. Additionally, because of the somewhat sophisticated geometry, some angles at which solar radiation reaches the corresponding power generation tile may not be received. Moreover, because Cassegrain structures employ two reflectors, they are subject to more reflection loss relative to configurations that employ only a single reflector.

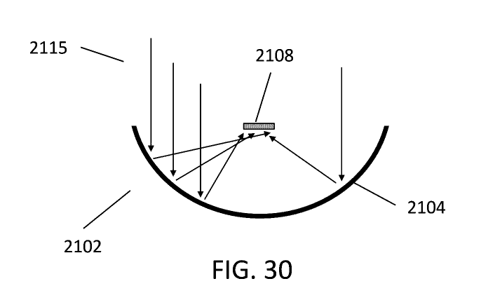

While Cassegrain structures have been discussed, it should be clear that any of a variety of concentrator configurations can be implemented. For example, in many instances, ‘Parabolic Trough’ configurations are implemented. Parabolic Trough configurations are similar to the Cassegrain structures discussed above, except that they do not include a secondary reflector; rather the primary reflector is used to redirect solar radiation onto an opposingly disposed photovoltaic material. For example, FIG. 30 illustrates the generalized understanding of the operation of a Parabolic Trough configuration. In particular, it is illustrated that the Parabolic Trough configuration 2102 includes a parabolic reflector 2104, and an opposingly disposed photovoltaic material 2108. Light rays 2115 are depicted that are redirected by the parabolic reflector 2104 onto the photovoltaic material 2108. Again, it should be clear that the precise manifestation of these operating principles are not requisite. Rather, the understood generalized operating principles are discussed here to facilitate the understanding of the discussed structure. Additionally, it should be noted that while FIG. 30 depicts the operation of a single Parabolic Trough unit, a power generation tile can of course includes a plurality of such Parabolic Trough units.

While the reflector can conform to any shape that redirects solar radiation to a photovoltaic material, it can be advantageous if it conforms to a parabolic shape so as to efficiently focus solar radiation onto the opposingly disposed photovoltaic material. Additionally, as can be appreciated from the discussion above, the configurations can be implemented using any of a variety of materials. For example, in many instances, the concentrator is implemented using a reflective surface, such as aluminum, silver, and/or a dielectric material, in conjunction with a lightweight substrate. Additionally, the photovoltaic material can be any suitable material, such as—but not limited to—thin film photovoltaics produced by ALTADEVICES.

Parabolic Trough configurations can be advantageous relative to Cassegrain structures in that, since they only employ a single reflector (as opposed to two reflectors), they are subject to less reflective loss relative to Cassegrain structures that implement two reflectors. However, as the photovoltaic material is not typically directly coupled to a large surface area such as the primary reflector (as in the case of a Cassegrain structure), Parabolic Trough configurations may not be as efficient at radiative heat transfer.

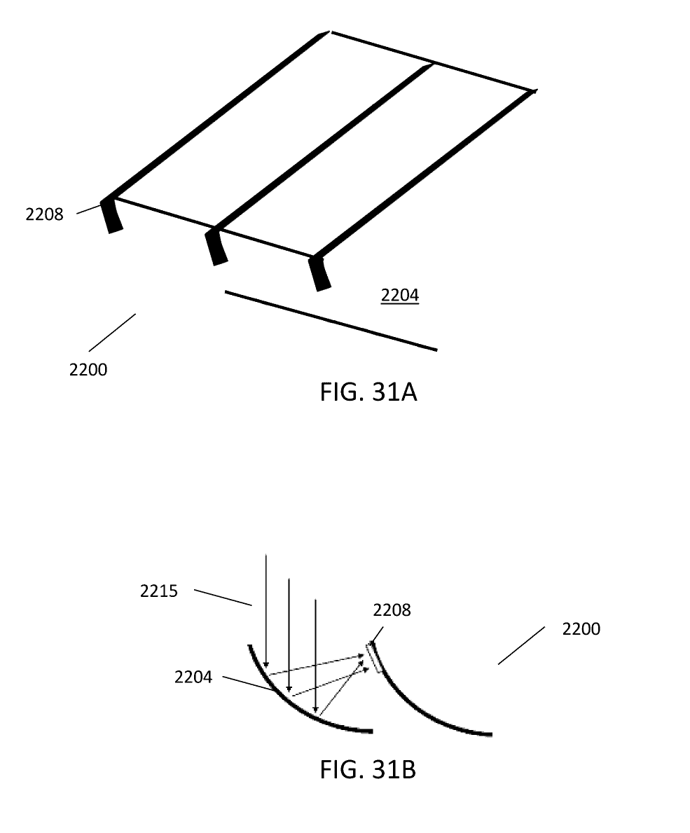

In many instances, a ‘Venetian Blinds’ configuration is implemented, whereby concentrators redirect solar radiation towards photovoltaic materials that are disposed on the backside of adjacently disposed concentrators. FIGS. 31A and 31B illustrate a Venetian Blinds configuration that can be implemented in accordance with certain instances. More specifically, FIG. 31A illustrates an isometric view of a Venetian Blinds configuration. In particular, it is depicted that the configuration 2200 includes a plurality of concentrators 2204, each having a photovoltaic material 2208 disposed on its backside. The photovoltaic materials are disposed such that the concentrators 2204 redirect solar radiation onto a photovoltaic material that is disposed the on backside of an adjacent concentrator. FIG. 31B illustrates a generalized understanding of the operation of the Venetian Blinds configuration. In particular, it is illustrated that light rays 2215 are redirected by a respective reflector 2204 onto a photovoltaic material 2208 that is disposed on the backside of an adjacent reflector. As can be gathered from the above discussion, the reflectors 2104 can be curved so as to focus the solar radiation on to the targeted photovoltaic material 2208. It should be clear that the described configurations are not constrained to the precise manifestation of these operating principles. Rather, the understood generalized operating principles are discussed here to facilitate the understanding of the discussed structure.

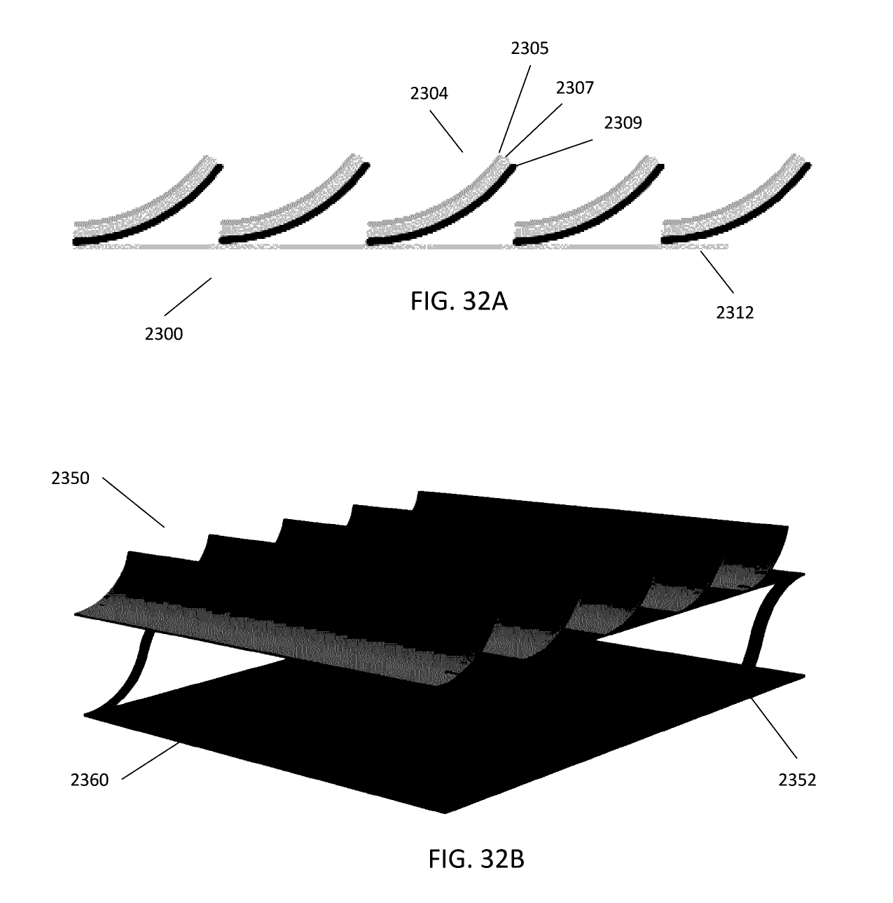

Venetian Blinds configurations can be constructed using any of a variety of materials and techniques. For example, in several instances, Venetian Blinds configurations are implemented using polyimide films in conjunction with carbon springs, and reflectors. FIG. 32A illustrates a cross section of a Venetian Blinds configuration that depicts materials that can be used in its construction. In particular, it is illustrated that the Venetian Blinds configuration 2300 includes reflectors 2304 that are characterized by a reflective surface 2305 disposed on a KAPTON polyimide layer 2307, that is itself utilized in conjunction with a carbon springs 2309. As can be appreciated, the springs can help the power generation tile deploy, and also aid in structural integrity. The plurality of reflectors 2304 can be disposed on a KAPTON polyimide substrate 2312. This recited combination of materials has been shown to be particularly effective for the intended operation, as the carbon springs and polyimide films have demonstrated sufficient pliability and durability for operation in space. Although, it should again be clear that while certain materials are referenced, any suitable materials can be incorporated. For instance, any of a variety of spring materials can be incorporated, including any of a variety of conductive spring materials, and nonconductive spring materials.

To provide context, FIG. 32B illustrates a Venetian Blinds configuration in conjunction with a power transmitter. In particular, it is depicted that a Venetian Blinds configuration 2350 is disposed above a power transmitter 2360, and adjoined to the power transmitter via four “s-shaped” struts 2352. Of course it should be clear that the power transmitter and struts can be implemented in any of a variety of ways and can conform to any of a variety of suitable. The depiction is meant to be illustrative and not exhaustive of configurations that can be implemented.

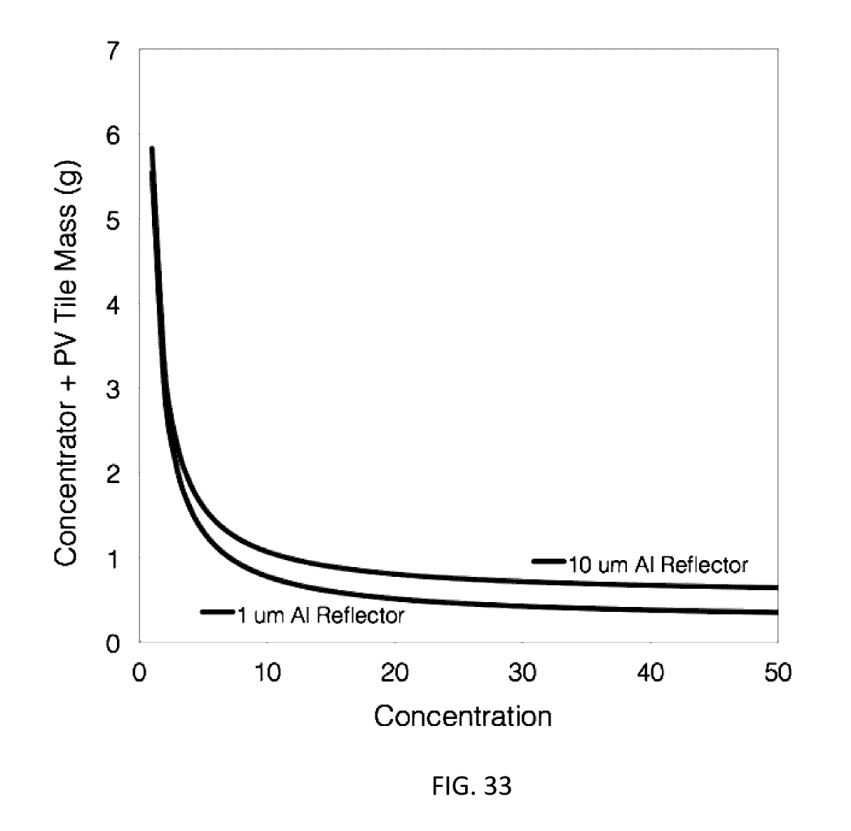

Venetian Blinds configurations can be advantageous insofar as each of the concentrators can act as a heat sink for a coupled photovoltaic material, thereby facilitating conductive and radiative cooling, and consequently a more efficient operation. Additionally, in contrast to the Cassegrain configuration, only a single reflector is used in redirecting solar radiation onto a photovoltaic material. As alluded to above, using a single reflector can reduce the potential energy loss relative to configurations that incorporate a plurality of reflectors. In many instances, optical efficiencies of greater than 90% can be realized using Venetian Blind configurations. Moreover, such configurations can result in concentrations of between approximately 10× to approximately 40× or more. FIG. 33 illustrates a chart demonstrating how the combined mass of a concentrator and a PV tile diminishes as a function of concentration. In particular, the data in the graph is for a 10 cm by 10 cm power generation tile, with five 1-dimensional Venetian Blinds, a 100 μm cover glass, with 30 μm copper back contact/structural support, a 1 μm GaAs photovoltaic film, supported by a 12.5 μm KAPTON polyimide substrate. Thus, it is illustrated how the mass of a corresponding power generation tile can be substantially reduced using concentrators.

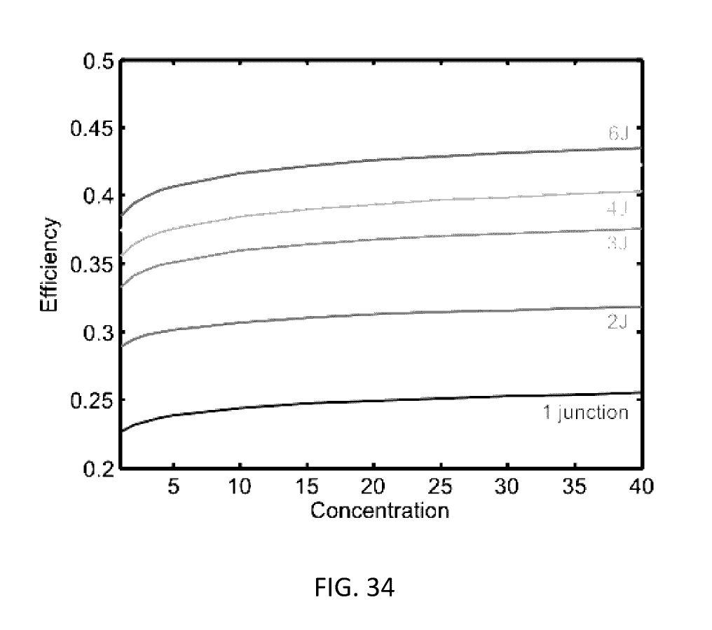

As noted above, the number of junctions within a photovoltaic material also influences the power generation efficiency. Interestingly, FIG. 34 depicts that the efficiency of a photovoltaic cell is a stronger function of the number of junctions incorporated than it is of solar radiation concentration. Accordingly, in many instances, photovoltaic materials are implemented that are characterized by multiple junctions are incorporated within a power generation tile.

In many instances, the contacts used by PV cells are integrated so as to facilitate the efficiency of the power generation tile. For instance, in many instances, conductive structures that already exist within a power generation tile are used as the conductive contacts of constituent PV cells. In this way, the conductive structures are made to be dual purpose. For example, in many instances, a Venetian Blinds configuration is implemented that includes a conductive reflector as well as carbon springs for structural support, and the conductive reflector and/or the carbon springs are used as the electrical contacts for the PV cell. This can be achieved in any of a variety of ways.

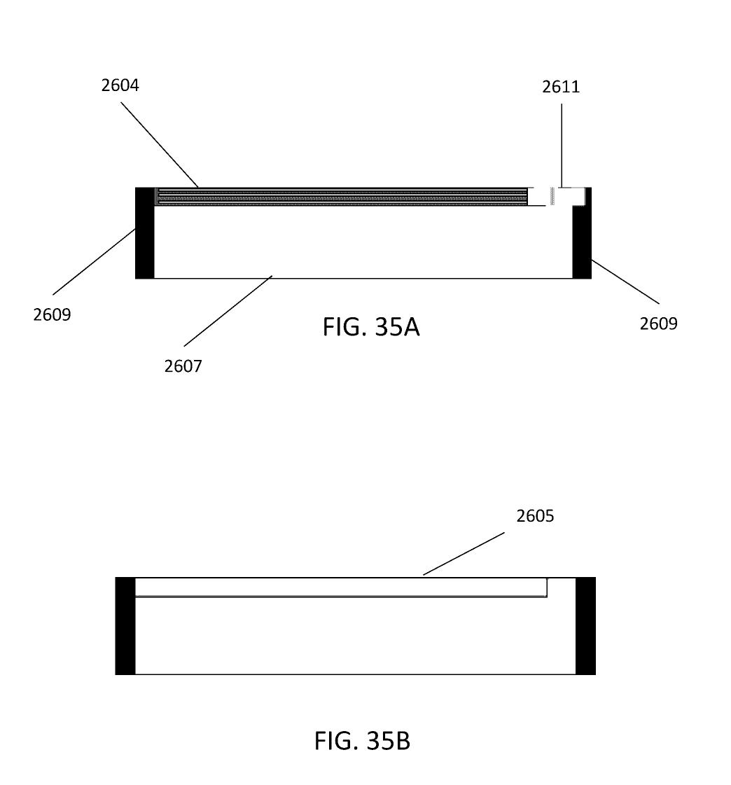

For instance, FIGS. 35A and 35B depict the utilization of a carbon spring and a reflector as the contacts for a corresponding PV cell in accordance with one instance. In particular, FIG. 35A depicts a photovoltaic material 2604 within a Venetian Blind structure that includes carbon springs 2609, a KAPTON polyimide substrate 2607, and a conductive tape bond 2611. FIG. 35B illustrates the same structure without the photovoltaic material to indicate that the conductive reflective surface 2605 is exposed and can make direct contact with the utilized photovoltaic material 2604. This geometry can be achieved in any of a variety of ways. For example, that portion of the KAPTON polyimide surface can be excised so that the photovoltaic material can directly contact the conductive reflective surface. Similarly, a conductive tape bond 2611 is used to couple the opposing side of the photovoltaic material 2604 to a carbon spring. As can be appreciated, the carbon spring 2609 and the reflective surface 2605 can be electrically isolated. Thus, the conductive reflective surface 2605 and the carbon spring 2609 can serve as opposing contacts for the photovoltaic material. In this way, as can be appreciated, each of the reflector 2605 and the carbon spring 2609 can provide multiple functions: (1) the reflector can redirect incident solar radiation onto a photovoltaic material and also serve as a contact for a photovoltaic material; and (2) the carbon spring can allow the Venetian Blind to deploy, provide structural support, and serve as a contact for a photovoltaic material.

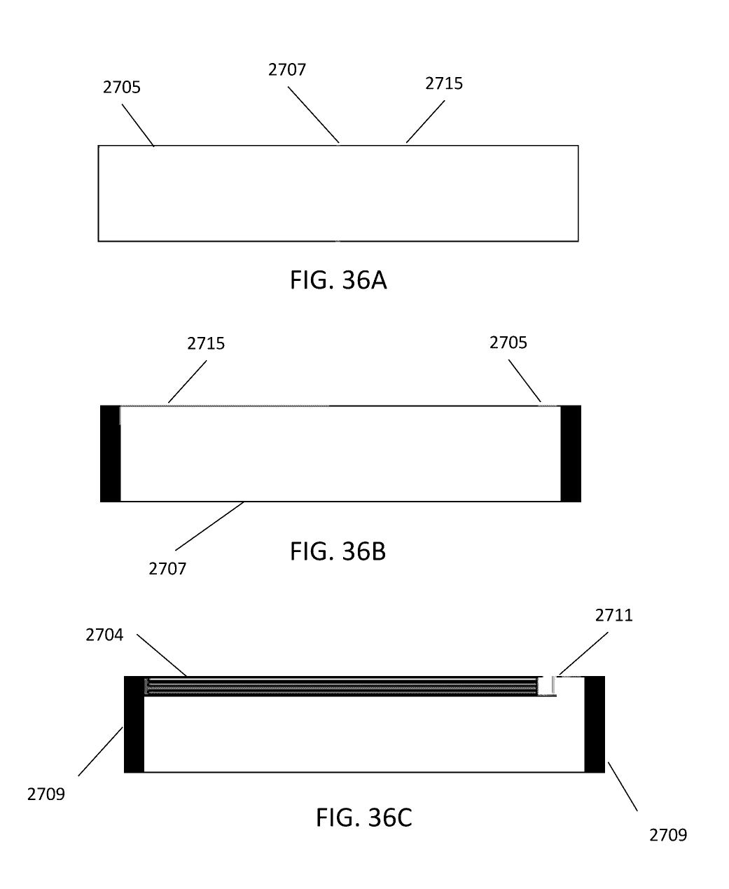

In many instances, a reflector is used to implement the contacts for a PV cell. For example, FIGS. 36A-36C depict utilizing a reflector to implement the contacts for a photovoltaic material. In particular, FIG. 36A illustrates the reflector side of a Venetian Blind structure. More specifically, it is illustrated that the reflector has been bifurcated into two electrically isolated sides, 2705 and 2715. In particular, the underlying KAPTON polyimide structure 2707 serves to electrically isolate the two sides 2705 and 2715. FIG. 36B illustrates the opposing side of the Venetian Blind structure without the photovoltaic material 2704 and the tape bond 2711 to make clear that the photovoltaic material can be electrically connected with each of the two reflective sides 2705 and 2715. FIG. 36C illustrates the structure of FIG. 36B, except that it further includes the photovoltaic material 2704 and the tape bond 2711. More specifically, the underside of the photovoltaic material 2704 is directly connected to a first side 2715, while the opposing side of the photovoltaic material 2704 is tape bonded to the second side 2705 of the reflective surface. Thus, it is illustrated that a reflective surface can serve a secondary purpose by functioning as the contacts for a PV cell.

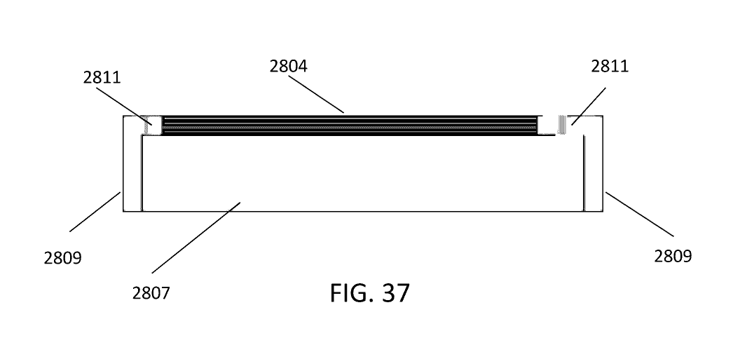

In numerous instances, carbon springs within a power generation tile act as the contacts for a PV cell. For example, FIG. 37 illustrates how the carbon springs within a Venetian Blind structure can act as the contacts for a corresponding photovoltaic material. In particular, FIG. 37 illustrates a Venetian Blind structure including a photovoltaic material 2804, a KAPTON polyimide substrate 2807, carbon springs 2809, and tape bonding 2811 (the opposing reflective surface is not depicted). In particular opposing surfaces are of the photovoltaic material 2804 are electrically connected to respective carbon springs 2809 using respective tape bonds 2811, which can thereby function as electrical contacts for the associated photovoltaic material. While several examples of utilizing already existing hardware as electrical contacts for PV cells, it should be clear that the discussed examples are illustrative and are not meant to be comprehensive. For example, while the discussed examples have regarded Venetian Blind configurations, in many instances, Cassegrain configurations and/or Parabolic Trough configurations utilize existing conductive structures to act as electrical contacts. Already existing conductive structures can function as PV cell contacts in any of a variety of ways. Moreover, as can be appreciated, while the implementation of several materials has been discussed, it should be clear that any of a variety of suitable materials can be implemented to construct the described structures.

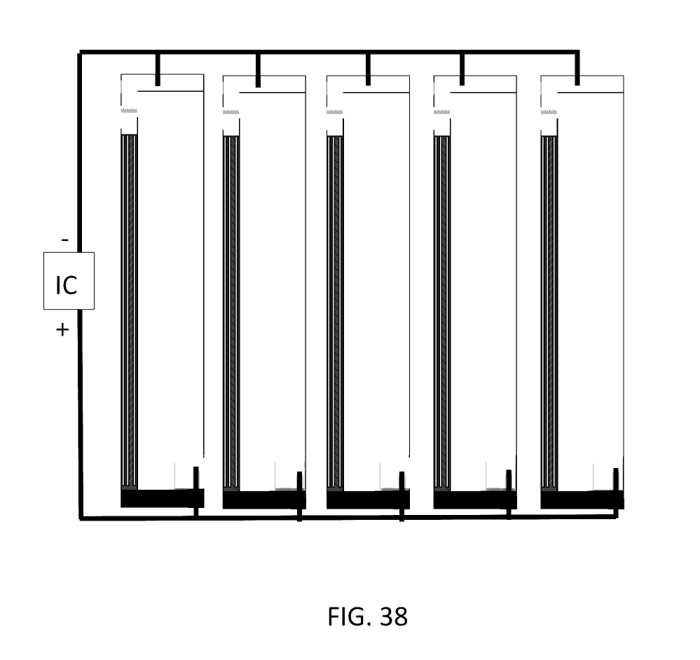

To provide context, FIG. 38 illustrates how the photovoltaic materials may be interconnected in generating electrical energy. In particular, FIG. 38 illustrates how a plurality of Venetian Blind structures can be electrically connected in parallel. Of course, it should be clear that the photovoltaic materials can be adjoined in any suitable way in. For example, in many instances, the photovoltaic materials are connected in series.

While the above descriptions have largely regarded suitable space-based solar stations that can benefit from the incorporation of microstructures, it should be clear that the previously described microstructures can be implemented in any of a variety of apparatus configured for extraterrestrial operation. More generally, while particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A lightweight solar power generator comprising:
at least one photovoltaic cell including a photovoltaic material;
at least one concentrator, configured to focus incident solar radiation onto the photovoltaic material;
at least one power transmitter, including at least one transmission antenna, wherein the power transmitter is configured to receive electrical current from the photovoltaic cell and convert the electrical current to a wireless power transmission; and
at least one textured metasurface characterized by its inclusion of a plurality of microstructures, each having a characteristic lateral dimension of between approximately 1 μm and approximately 100 μm patterned thereon;
wherein the at least one textured metasurface is disposed such that it is in thermal communication with at least some portion of the lightweight solar power generator that generates heat during the normal operation of the lightweight solar power generator, and is thereby configured to dissipate heat generated by the at least some portion.

2. The lightweight solar power generator of claim 1, wherein the microstructures are each characterized by a lateral dimension of between approximately 5 μm and approximately 50 μm.

3. The lightweight solar power generator of claim 1, further comprising a circuit that generates heat during the normal operation of the lightweight solar power generator, wherein the textured metasurface is disposed in thermal communication with the circuit and is thereby configured to dissipate heat generated by the circuit.

4. The lightweight solar power generator of claim 1, wherein the textured metasurface is disposed in thermal communication with the at least one concentrator.

5. The lightweight solar power generator of claim 1, wherein the textured metasurface is disposed in thermal communication with the at least one photovoltaic cell.

6. The lightweight solar power generator of claim 1, wherein each of the microstructures is characterized by symmetry about an axis orthogonal to that portion of the surface that each respective microstructure is disposed on.

7. The lightweight solar power generator of claim 6, wherein at least one microstructure is hemispherical.

8. The lightweight solar power generator of claim 6, wherein at least one microstructure is conical.

9. The lightweight solar power generator of claim 6, wherein at least one microstructure is cylindrical.

10. The lightweight solar power generator of claim 6, wherein at least one microstructure conforms to the shape of a rectangular prism.

11. The lightweight solar power generator of claim 6, wherein at least one microstructure is spherical.

12. The lightweight solar power generator of claim 1, wherein each of the plurality of microstructures have an identical shape.

13. The lightweight solar power generator of claim 1, wherein the microstructures are characterized by a height of between approximately 1 μm and 10 μm.

14. The lightweight solar power generator of claim 13, wherein the microstructures are characterized by a height of between approximately 2.5 μm and approximately 5 μm.

15. The lightweight solar power generator of claim 1, wherein the plurality of microstructures are disposed in a grid-like manner characterized by a period of between approximately 1 μm and approximately 100 μm, and a duty cycle of between approximately 0.1 and 0.8.

16. The lightweight solar power generator of claim 15, wherein the plurality of microstructures are disposed in a grid-like manner characterized by a period of between approximately 1 μm and approximately 20 μm.

17. The lightweight solar power generator of claim 1, wherein the plurality of microstructures comprises at least one of: KAPTON polyimide and SiO₂.

18. The lightweight solar power generator of claim 1, wherein the plurality of microstructures are disposed on a layer of chromium.

19. The lightweight solar power generator of claim 18, wherein the layer of chromium is approximately 2 nm in thickness.

20. The lightweight solar power generator of claim 19, wherein the layer of chromium is disposed on one of: a layer of SiO₂ and a layer of KAPTON polyimide.
